(19) United States
(12) Patent Application Publication
(10) Pub. No.: US 2002/0089542 A1
(43) Pub. Date: Jul. 11, 2002

(54) Computer program product, recording medium having screen component interface program code recorded therein, and screen program creating method

(76) Inventor: Daisuke Imamura, Asaka-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/805,948

(22) Filed: Mar. 15, 2001

(30) Foreign Application Priority Data
May 1, 2000 (JP) 2000-132694
Feb. 23, 2001 (JP) 2001-048494

(51) Int. Cl. G09G 5/00

(52) U.S. Cl. 345/764; 345/810

(57) ABSTRACT

A computer program product stored on a computer-readable medium for controlling a screen, the program product comprising a first program code that acquires dynamic display processing identification information for specifying dynamic display processing reserved for acquiring display contents to be dynamically changed and display attribute information used by dynamic display processing specified by this dynamic display processing identification information, and a second program code that provides the display attribute information corresponding to dynamic display processing for dynamic display processing specified by the dynamic display processing identification information acquired by the first program code.

### CROSS-REFERENCE TO RELATED APPLICATIONS

This application is based upon and claims the benefit of priority from the prior Japanese Patent Applications No. 2000-132694, filed May 1, 2000; and No. 2001-048494, filed Feb. 23, 2001, the entire contents of both of which are incorporated herein by reference.

### BACKGROUND OF THE INVENTION

The present invention relates to a recording medium having recorded therein a screen control program that configures a screen program for displaying a screen on a display and accepting a user interactive input, a recording medium having a dynamic display information acquisition program recorded therein, a recording medium having a screen component interface program recorded therein, and a screen program creating method.

In the case where a user creates a screen program for interactively inputting data, there is used a method of describing and creating a screen program by using a programming language.

In addition, another screen program creating method includes generating a program source concerning a screen while a screen image is graphically edited by using a development tool.

Further, there is used a method of defining screen layout information in a file or the like, and then, program reading the screen layout information, thereby displaying the screen.

Of these three types of screen program creating methods, in the case where there is used a method of describing a screen program by using a program language, the degree of freedom in program becomes higher, but an amount of description increases. In addition, in the case of changing a program, it is required to edit and compile such program. Therefore, the improvement of development efficiency is difficult.

In the case of using a screen program development tool, the screen layout is easily created. However, processing required for screen display must be described in a programming language. Therefore, even if this method is used, it may be difficult to create the screen program. In addition, with this method, in the case where a layout change is required, compiling is required. Screen program creation and change are cumbersome.

In the case where screen layout information is defined in advance, and is read during execution, even in the case where a screen layout is changed, it is not required to edit and compile a program source. Therefore, program development efficiency is improved by using this method. However, this method limits an amount of layout information that can be defined outside of the program, and the degree of freedom and expandability are not high. For example, when this method is used, specification of the size of parts that configure a screen, position, color type and character allocated on the screen can be defined as layout information. On the other hand, in the case of using this method, processing required for screen display must be defined in a program, and such processing cannot be defined outside of the program unlike layout information. Therefore, the processing required for screen display must be described in a program. In addition, in the case of changing the processing required for screen display, the created program must be compiled.

In this way, in the case of using the above three types of screen program creating methods, the processing required for screen display must be described in a programming language. In addition, the above program must be compiled during processing change. Thus, there is a problem that an amount of development work increases.

Further, what is a problem in a variety of application programs (hereinafter, referred to as “application”) is state management of application if a failure occurs. It is a routine practice to restore contents of a database in response to a failure with transaction processing. On the other hand, in the case where a transaction processing failure occurs, it is desired to restore a screen input state similarly. In the case where an application is restored from its failure, it is not efficient for a user to re-input the inputted contents before a failure occurs in response to the screen.

However, a large amount of work load is required for program development for restoring a screen display state in its proper state.

In addition, processing to be executed in an application screen program can be customized as data key input acceptance processing, selection acceptance processing based on listings, processing for requesting execution of a program (business logic) or the like.

The data key input acceptance processing used here denotes processing for displaying a text field to accept a user text input. The data key input acceptance processing executes a validation of the inputted test and an operation according to the validation result.

The selection acceptance processing based on listings denotes processing for acquiring a list of selections from a database or file, and displaying the list to accept a user selection.

The program execution request processing denotes processing for acquiring data inputted by pressing an execution button, passing the thus acquired data to a program, and acquiring execution of such program or processing for transmitting the acquired data to a server program.

Conventionally, in the case of creating a screen program for executing data key input acceptance processing, a developer must describe a program for executing input validation for parts by key input event after the personnel have defined disposition of screen components such as text field.

In addition, in the case where creating a screen program for executing selection acceptance processing based on listings, the developer must describe a program for acquire list data and setting the acquired data to the screen components.

In addition, in the case where creating a screen program for requesting program execution, the developer must describe a program for acquiring data on each screen component disposed on a screen by a button pressing event, converting the data into a format in which the data is passed to a program or server, and calling a program or server.

However, it is cumbersome that such work is performed every time a screen program is created.

Further, in the case of creating a complicated screen program, one screen must be created by sharing it with a plurality of developers. However, conventionally, it has been difficult to divide one screen into a plurality of units, and creating the screen program for each of these units.

### BRIEF SUMMARY OF THE INVENTION

It is an object of the present invention to provide a recording medium having recorded therein a screen control program for efficiently and easily developing a screen program with its high expandability, and improving failure resistance of the screen program, a recording medium having a dynamic display information acquisition program recorded therein, a recording medium having a screen display transaction program recorded therein, a recording medium having a screen component interface program recorded therein, and a screen program creating method.

According to a first aspect of the present invention, there is provided a computer program product stored on a computer-readable medium for controlling a screen, the program product comprising:

a dynamic display information acquisition program code that acquires dynamic display processing identification information for specifying dynamic display processing reserved for acquiring display contents to be dynamically changed and display attribute information used by dynamic display processing specified by this dynamic display processing identification information; and

an attribute information providing program code that provides the display attribute information corresponding to dynamic display processing for dynamic display processing specified by the dynamic display processing identification information acquired by the dynamic display information acquisition program code.

The spirit of the first aspect of the present invention is that dynamic display processing is reserved for acquiring display contents to be dynamically changed, and a screen program can be configured by specifying an attribute used during this dynamic display processing.

In the case where using a program product according to the first aspect of the present invention, the developer may specify dynamic display processing and display attribute information. In this manner, the developer may not describe processing for displaying dynamically changed contents on a screen at a time when the contents are displayed in a programming language, and can create a screen program easily. In addition, the developer may not compile a screen program being created during creation or change of the screen program.

Therefore, the developer can develop a screen program with its high expandability efficiently.

According to a second aspect of the present invention, there is provided a computer program product stored on a computer-readable medium for controlling a screen as the first aspect of the present invention, wherein the attribute information providing program code incorporates dynamic display processing specified by dynamic display processing identification information acquired by the dynamic display information acquisition program code.

That is, in the second aspect of the present invention, a dynamic display processing specified by the developer is plugged-in relevant to attribute information providing program code, enabling use based on display attribute information.

In this manner, the developer can reduce a work load of describing a program during creation or change of the screen program.

That is, the developer can use and change a processing to be incorporated in the screen program merely by specifying dynamic display processing and display attribute information.

According to a third aspect of the present invention, there is provided a computer program product stored on a computer-readable medium for controlling a screen as the first aspect of the present invention, wherein the dynamic display processing is processing for carrying out search based on the contents of display attribute information.

In this manner, in the case of creating a screen program for displaying data searched according to one key on a screen, the developer merely specifies dynamic display processing for carrying out search, and specifies that key as display attribute information. Therefore, an effect similar to the above can be achieved.

Dynamic display processing in the second invention may be search processing.

In addition, other examples of dynamic display processing include: input validation processing for, if an error occurs as a result of validating the input contents, returning the fact; and popup processing for popping up a new screen.

According to a fourth aspect of the present invention, there is provided a computer program product stored on a computer-readable medium for acquiring a dynamic display information, the program product comprising:

a acquiring program code that acquires dynamic display processing identification information for specifying dynamic display processing reserved for acquiring display contents to be dynamically changed and display attribute information used by dynamic display processing specified by this dynamic display processing identification information; and

a providing program code that provides the dynamic display processing identification information and display attribute information acquired by the acquiring program code to a screen control program code that provides the display attribute information used in the dynamic display processing to dynamic display processing specified by the dynamic display processing identification information.

The computer program product in the fourth aspect of the present invention is a dynamic display information acquisition program code in the first aspect of the present invention.

According to a fifth aspect of the present invention, there is provided a computer program product stored on a computer-readable medium for acquiring a dynamic display information as the fourth aspect of the present invention, further comprising:

a format converting program code that converts the dynamic display processing identification information and display attribute information described in a predetermined format in a format that can be handled by a screen control program code.

In this manner, for example, the dynamic display processing identification information and display attribute information are accepted as a file described in a predetermined format such as XML (Extensible Martup Language) file, HTML (HyperText Markup Language) file, CSV file, the contents are converted so as to be handled by a screen control program code at a later stage, and a file after converted can be provided to the screen control program code.

According to a sixth aspect of the present invention, there is provided a computer program product stored on a computer-readable medium for transacting a screen display, the program product comprising:

a storage program code that judges whether or not the contents of input to the screen are normal, and in the case where it is judged that the contents are normal, stores the input contents as screen display transaction information; and

a reproduction program code that, in the case where a re-display instruction is accepted, reproduces normal input contents at an arbitrary time on a screen by referring to the screen display transaction information stored by the storage program code.

The program product in the sixth aspect of the present invention can be used as one of the above dynamic display processing. When this program product is used, if a failure occurs during screen input operation, and then, the computer is restored from such failure, normal input contents at an arbitrary time before the failure occurs can be re-displayed.

Therefore, user operation can be made efficiently, and the failure resistance of the screen program can be improved.

According to a seventh aspect of the present invention, there is provided a computer readable recording medium having recorded therein a screen component interface program code that exchanges data between a screen components hierarchically combined to configure a screen program.

By using the recording medium according to the seventh aspect of the present invention, data can be exchanged between a management type screen component and a managed type screen component, and the screen program can be easily created.

According to an eighth aspect of the present invention, there is provided a computer readable recording medium having recorded therein a screen component interface program code that exchanges data between a screen component reserved for configuring a screen program and a custom component loaded to add at least one of the functions and data to this screen component.

By using the recording medium according to the eighth aspect of the present invention, data can be easily exchanged between a screen component and a custom component loaded to this screen component. In addition, the custom component can be easily created. Therefore, the screen program can be easily created.

By using the recording medium having the above program recorded therein, the above described function can be simply added to a computer system that does not have the above described function, for example, server or client computer and the like.

According to a ninth aspect of the present invention, there is provided method for creating a screen program by a computer system, comprising the steps of:

displaying a screen for causing a user to select a screen component reserved for configuring a screen program and its disposition position;

receiving (inputting) a user selection contents of the screen component and its disposition position;

displaying a screen for causing a user to select a custom component loaded to add at least one of the functions and data to the screen component selected by the user;

receiving a user selection contents of the custom component; and

loading a custom component to the screen component selected by the user to be provided as a constituent element of the screen program.

By using this method, the screen program can be easily created by the developer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram depicting a function executed on a computer by a screen control program according to a first aspect of the present invention;

FIG. 2 is a view showing a specific example of layout information;

FIG. 3 is a view illustrating processing procedures when layout information is read in the screen control program;

FIG. 4 is a flow chart illustrating each field creation processing repeated by the number of <field> tags;

FIG. 5 is a view illustrating a screen configured by processing a control function based on layout information

FIG. 6 is a view showing a modified example of processing procedures when layout information is read by the screen control program;

FIG. 7 is a sequence chart illustrating processing procedures for input validation procedure executed by the screen control program in accordance with an input validation attribute defined in layout information;

FIG. 8 is a view illustrating a screen if an error occurs as a result of input validation;

FIG. 9 is a view showing a specific example of dynamic display information;

FIG. 10 is a sequence chart illustrating processing procedures when dynamic display information is read by the screen control program;

FIG. 11 is a view illustrating a screen configured by processing a control function based on dynamic display information;

FIG. 12 is a sequence chart illustrating a modified example of processing procedures when dynamic display information is read by the screen control program;

FIG. 13 is a sequence chart illustrating processing procedures executed by the screen control program when a display attribute set relevant to a field is “search”;

FIG. 14 is a flow chart illustrating screen control program processing when the display attribute set relevant to the field is “search”;

FIG. 15 is a view illustrating a screen in which dynamic display contents are acquired by a search processing component, and a searched list is displayed based on a user operation;

FIG. 16 is a sequence chart illustrating processing procedures executed by the screen control program when the display attribute set relevant to the field is “popup”.

FIG. 17 is a sequence chart illustrating procedures for popup processing activated by the user field operation;

FIG. 18 is a view showing a screen on which a popup window is displayed;

FIG. 19 is a view showing a screen on which data selected on the popup window is set relevant to the field;

FIG. 20 is a sequence chart illustrating processing procedures for restoring screen display by using a screen display transaction function;

FIG. 21 is a block diagram depicting a function executed on a computer by a screen control program according to a second embodiment of the present invention;

FIG. 22 is a sequence chart illustrating processing procedures when layout information is read by the screen control program according to the second embodiment;

FIG. 23 is a block diagram depicting a function executed on a computer by a screen control program according to a third embodiment of the present invention;

FIG. 24 is a block diagram depicting a function executed on a computer system by a screen control program according to a fourth embodiment of the present invention;

FIG. 25 is a block diagram depicting a function executed on a computer system by a screen control program according to a fifth embodiment of the present invention;

FIG. 26 is a block diagram depicting a function executed on a computer system by a screen control program according to a sixth embodiment of the present invention;

FIG. 27 is a view showing a screen being changed according to a seventh embodiment of the present invention;

FIG. 28 is a view illustrating a configuration of a screen after changed as a result of input of dynamic display processing identification information and display attribute information;

FIG. 29 is a view illustrating a state of a screen when a list display button is pressed;

FIG. 30 is a view illustrating a state of a screen when there is activated a popup processing component plugged-in relevant to a “transfer destination” field;

FIG. 31 is a view illustrating a state of a screen when search results are selected;

FIG. 32 is a block diagram illustrating a state of data exchange caused by an interface function of a GUI component according to an eighth embodiment of the present invention;

FIG. 33 is a view showing a screen of an initial state of a screen creating tool according to the eighth he embodiment;

FIG. 34 is a view showing a state in which a panel is disposed on a screen creating tool screen according to the eighth embodiment;

FIG. 35 is a view showing a state in which a text field is disposed on a panel by the screen creating tool according to the eighth embodiment;

FIG. 36 is a class chart showing a configuration between a GUI component and a custom component according to a ninth embodiment of the present invention;

FIG. 37 is a view illustrating a relationship between a management type component and a managed type component;

FIG. 38 is a sequence chart illustrating processing procedures between the management type component and the managed type component;

FIG. 39 is a view illustrating a relationship between a base component and a custom component in a panel component;

FIG. 40 is a sequence chart illustrating processing when an application has made a submit operation for the panel component;

FIG. 41 is a sequence chart illustrating processing when a panel component submit operation has been made based on a user button operation;

FIG. 42 is a sequence chart illustrating processing procedures between the panel component and a list search type custom component;

FIG. 43 is a sequence chart showing a relationship between base and custom components in a text field component; and

FIG. 44 is a sequence chart illustrating processing procedures between the base and custom components in the text field component.

### DETAILED DESCRIPTION OF THE INVENTION

Hereinafter, preferred embodiments of the present invention will be described with reference to the accompanying drawings.

(First Embodiment of the Invention)

The first embodiment describes a screen control program for dynamic display information for specifying processing required for screen display as well as layout information, and displaying an application (business application) screen.

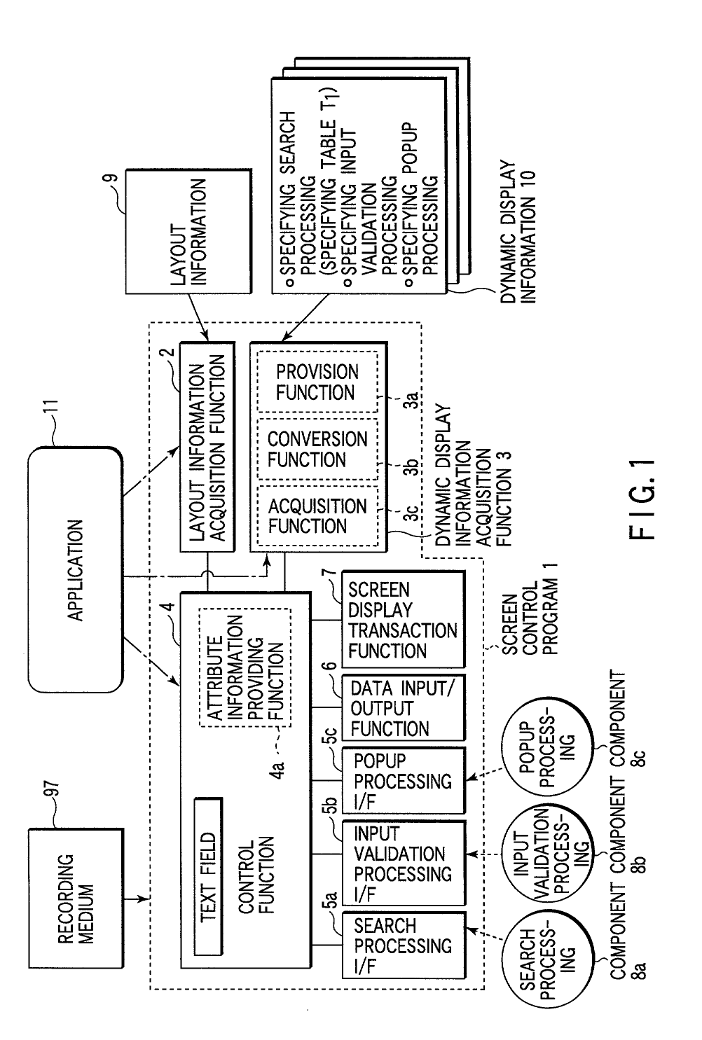

FIG. 1 is a block diagram depicting a function executed on a computer by a screen control program according to the present embodiment.

A screen control program 1 according to the present embodiment primarily executes a layout information acquisition function 2, a dynamic display information acquisition function 3, and a control function 4 on a computer system. In addition, the screen control program 1 comprises a search processing interface 5a, an input validation processing interface 5b, and a popup processing interface 5c. Further, the screen control program 1 executes a data input/output function 6 and a screen display transaction function 7 on a computer or computer system.

The screen control program 1 uses dynamic display processing functions (hereinafter, referred to as components) 8a to 8c created in advance to obtain display contents that are dynamically changed at a time when these functions are displayed on a screen such as input validation processing or popup processing, for example. The components 8a to 8c are already compiled, and are programs that are executable in their states.

A developer (screen display program creator) inputs layout information 9 and dynamic display information 10 concerning a screen of an application 11.

The layout information 9, as described previously, primarily describes static information fixedly determined when a screen such as a disposition position of parts for configuring the screen, size, colors or the like is configured.

The dynamic display information 10 describes dynamic display processing identification information specifying a component that a user want to use or display attribute information required for determining processing contents of this component. Here, the dynamic display information 10 describes dynamic display processing identification information for specifying search processing, input validation processing and popup processing, for example. In addition, the dynamic display information 10 describes display attribute information in which the contents of table T₁ is targeted for search in search processing.

The layout information acquisition information 2 analyzes the contents defined in the layout information 9, and conveys the analysis result to the control function 4.

The dynamic display information acquisition function 3 analyzes the contents defined in the dynamic display information 10, and conveys the analysis result to the control function 4. This dynamic display information function 3 is primarily composed of an acquisition function 3a, a conversion function 3b and a providing function 3c.

When the dynamic display information 10 described in a predetermined format is read by the acquisition function 3a, the contents of the description are converted by means of the conversion function 3b into a format that can be handled by the control function, and provided to the control function 4 by means of the providing function 3c.

An attribute information providing function 4a provided by the control function 4 performs control for plugging in a component specified by dynamic display processing identification information provided from the dynamic display information acquisition function 3. In addition, the attribute information providing function 4a provides the corresponding display attribute information to the plugged-in component, and acquires the result.

In addition, the control function 4 controls display or operation of a field (component for performing input/output on a screen, for example, text field).

A search processing interface 5a plugs in a search processing component 8a, searches a file or database table based on search display attribute information defined by dynamic display information 10, and returns the search result to the control function 4.

An input validation processing interface 5b plugs in an input validation processing component 8b, validates a value inputted to a field based on the input validation display attribute information defined by layout information 9 or dynamic display information 10, and returns the validation result to the control function 4.

A popup processing interface 5c plugs in a popup processing component 8c, displays a popup window based on the popup window defined by dynamic display information 10, and reflects the data determined on the popup window in the control function 4.

A data input/output function 6 acquires data inputted to a field on a screen, and sets the data provided from an application 11 to the field on the screen.

The screen display transaction processing function 7 creates and stores an object that indicates an input/output state when the input/output state is normal. In addition, in the case where the start of transaction is instructed relevant to the screen, this function restores screen display by using the stored object.

Now, an operation achieved by the above configuration will be specifically described here.

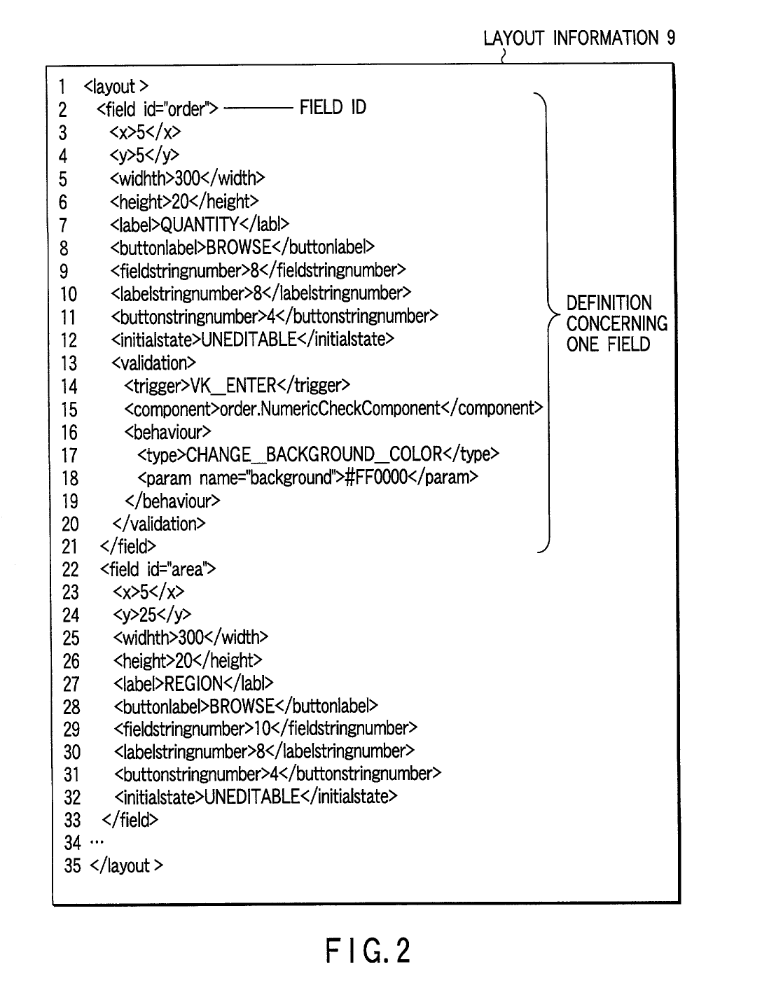

FIG. 2 is a view showing a specific example of layout information 9. Although this example of layout information 9 shows a case in which information is described by using XML, a CSV format, a format in which a specific character is defined as a delimiter, and a fixed length file format can be used.

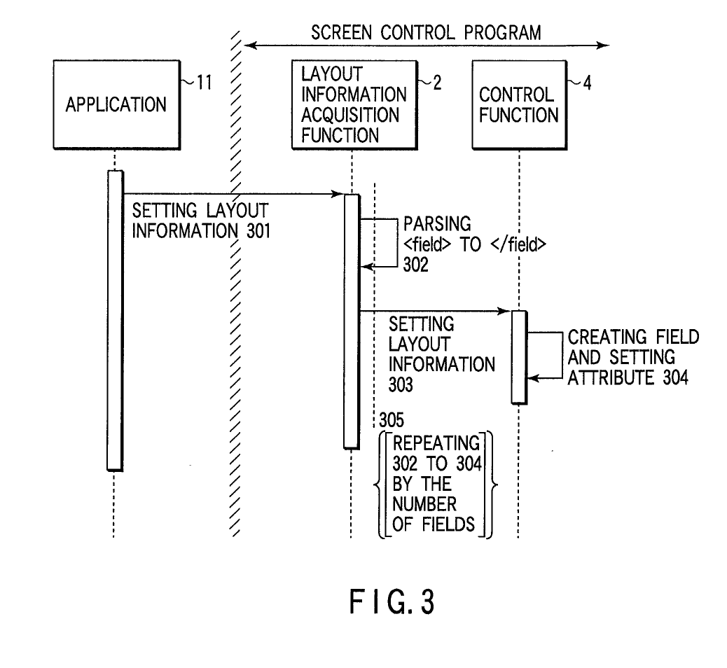

FIG. 3 is a sequence chart illustrating processing procedures when the screen control program 1 according to the present embodiment reads layout information 9.

First, the application 11 sets layout information 9 to the layout information acquisition function 2 (301). The layout information acquisition function 2 parses <field> to </field> shown in line 2 to line 21 of the layout information 9 shown in FIG. 2 as a definition for one field (302). An existing technique such as XML purser can be used for parsing an XML document.

The layout information acquisition function 2 sets parsed layout information for each field to the control function 4 (303).

The control function 4 creates a field in accordance with the set layout information (304). Then, the steps 302 to 304 are repeated by the number of <field> tags (305).

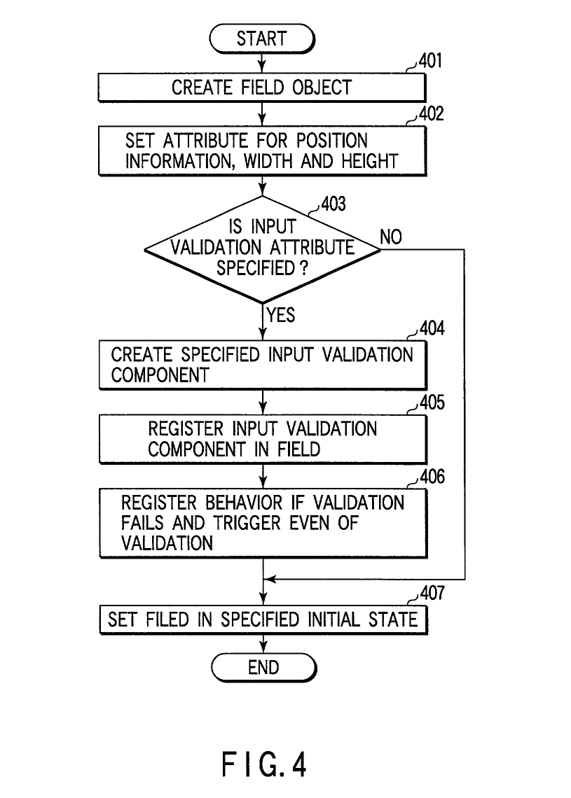

FIG. 4 is a flow chart illustrating each field creation processing repeated by the number of <field>tags.

The control function 4 creates a field object associating an ID specified in the <field> tag on line 2 of the layout information 9 shown in FIG. 2 (401).

Next, information concerning field display such as position attribute defined on lines 3 to 11 of the layout information 9 shown in FIG. 2 is set relevant to the created field object (402).

For example, the control function 4 sets a field label to a field object according to an attribute enclosed in a <label> tag on line 7 of the layout information 9 shown in FIG. 2.

Next, the control function 4 judges whether or not an input validation attribute is defined in the layout information 9 (403). The layout information 9 shown in FIG. 2 can be judged according to the presence or absence of a <validation> tag on line 13.

In the case where an input validation attribute is specified, the input validation component specified by the <component> tag on line 15 of the layout information 9 shown in FIG. 2 is created or a component instance is acquired (404). In the case of a Java language, an object can be created from a class name. This language can be used for this step 404.

Next, the control function 4 registers an input validation component in a field.

Next, the control function 4 registers in a field a key defined as a trigger for input validation shown on line 14 of the layout information 9 shown in FIG. 2 and an operation if an error occurs, which is shown on lines 16 to 19 (406).

Then, the control function 4 initializes a field so as to be specified on line 12 of the layout information 9 shown in FIG. 2, and completes processing (407). In this example, the initial state is specified as “UNEDITABLE”.

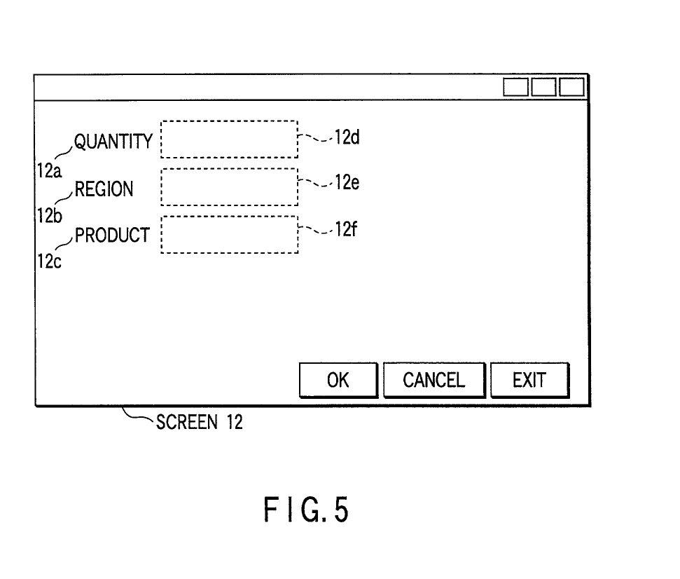

FIG. 5 is a view showing a screen configured by processing the control function 4 based on the above layout information 9.

A screen 12 created based on the layout information 9 displays screen elements such as labels 12a to 12c or initial fields 12d to 12f.

For example, the attribute enclosed in the <label> tag on line 7 of the layout information 9 shown in FIG. 2 corresponds to the label 12a of the field 12d. Thus, “Quantity” is displayed on the label 12a.

In addition, the fact that the initial state is specified as “UNEDITABLE” is described on line 12 of the layout information 9 shown in FIG. 2, and thus, the initial state of the field 12d enters uneditable.

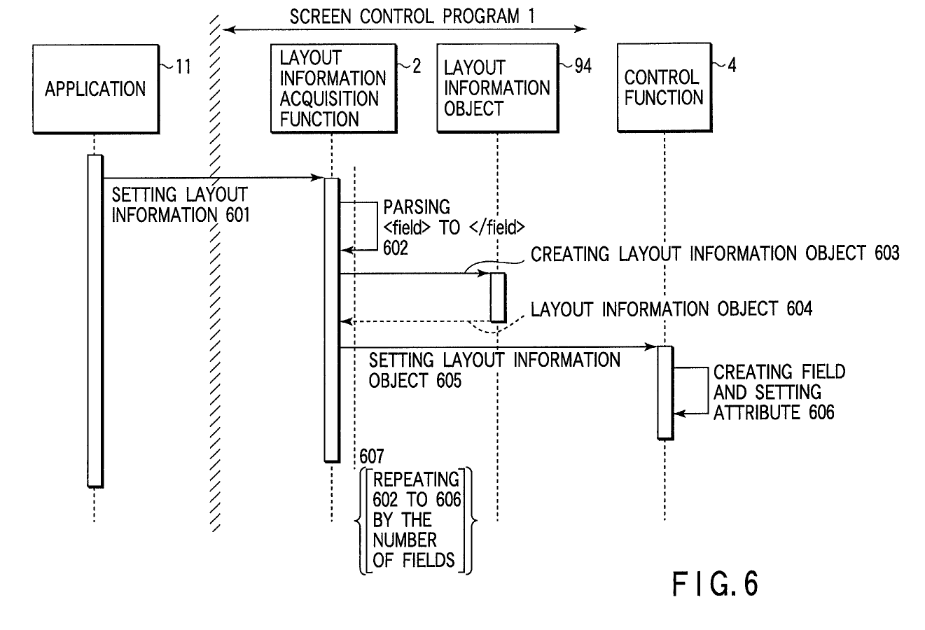

FIG. 6 is a sequence chart illustrating a modified example of processing procedures when the screen control program 1 reads layout information 9.

In this modified example, the application 11 sets layout information 9 to the layout information acquisition function 2 (601).

The layout information acquisition function 2 parses <field> to </field> as a definition for one field (602).

Next, the layout information acquisition function 2 creates a layout information object 94 having the layout information for one field stored therein (603, 604), and sets this layout information object 94 to the control function 4 (605).

The control function 4 creates a field, and sets an attribute (606).

Then, operations from the steps 602 to 606 are repeated by the number of fields (607).

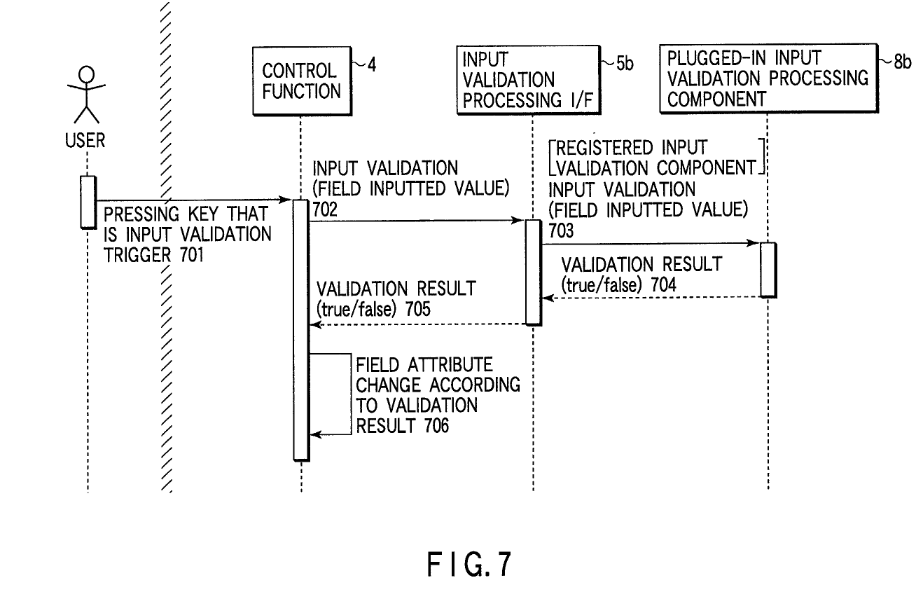

FIG. 7 is a sequence chart illustrating processing procedures for input validation processing executed by the screen control program 1 in accordance with the input validation attribute defined in layout information 9.

A user makes an operation defined as an input validation trigger after the user has inputted a value to a field (701). “VK_ENTER” is specified as an attribute enclosed in the <trigger> tag on line 14 of the layout information 9 shown in FIG. 2. This “VK_ENTER” denotes that an <Enter> key input is defined as an input validation trigger.

Through this trigger key input, the control function 4 passes a value inputted to the field to an input validation processing interface 5b, and instructs an input validation (702).

The input validation processing interface 5binstructs input validation to an input validation processing component 8b registered in the value inputted field (703).

The input validation processing component 8b judges the passed value by mounting the component itself, and returns to the input validation processing interface 5b whether or not an error occurs (705).

If an error occurs as a result of the validation, the control function 4 change a field attribute in accordance with the contents defined on lines 16 to 19 shown in FIG. 2.

Such operation is reserved in a program configuring a field because it is required in common. A file having layout information 9 described therein specifies processing selectively used from among the created programs. In this example, “CHANGE_BACKGROUND_COLOR” is defined in the <type> tag, and “background” is specified as #FF0000 in the <param> tag.

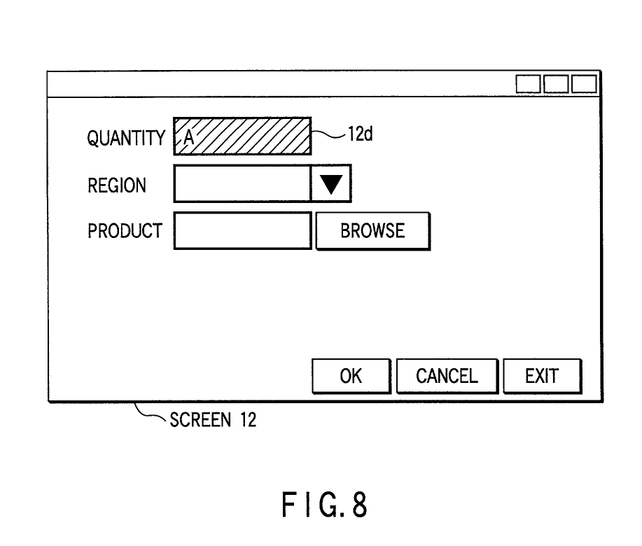

Therefore, as shown in FIG. 8, if an error occurs as a result of input validation, the background color of the field 12d becomes red.

Now, dynamic display information 10 featured in the present embodiment will be described here. The input validation attribute described in the above layout information 9 may be specified by this dynamic display information 10.

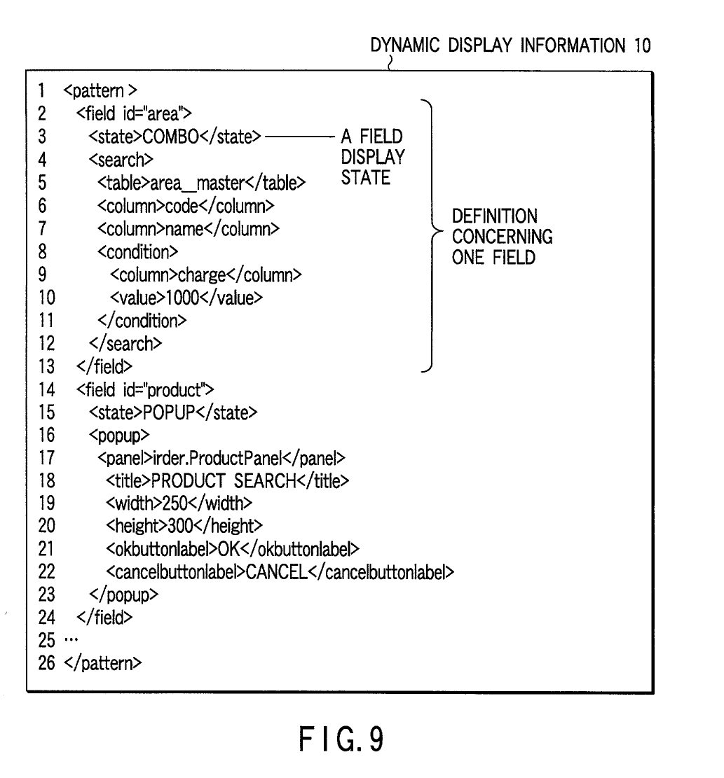

FIG. 9 is a view showing a specific example of dynamic display information 10.

Although this example of dynamic display information 10 shows a case when the information is described by using XML similar to the layout information 9, the display information may be described in a CSV format, a format in which a specific character is defined as a delimiter or a fixed length file.

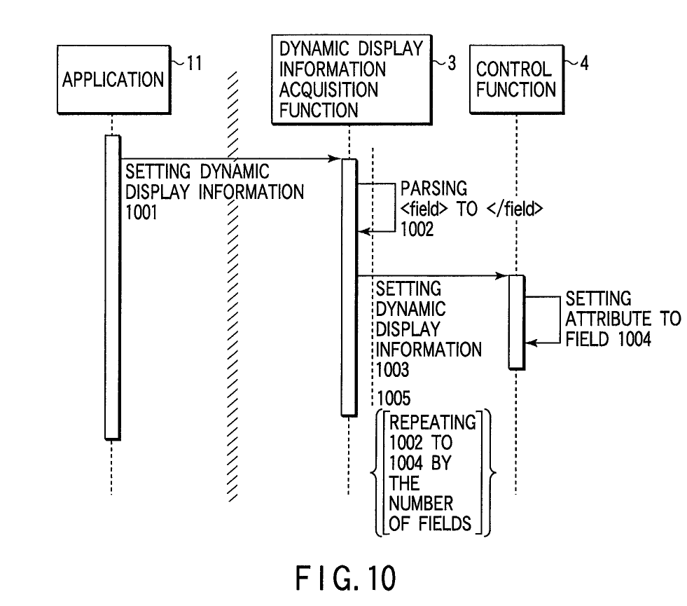

FIG. 10 is a sequence chart illustrating processing procedures when the screen control program 1 according to the present embodiment reads dynamic display information 10.

First, an application 11 sets dynamic display information 10 to a dynamic display information acquisition function 3 (1001). The dynamic display information acquisition function 3 parses <field> to </field> shown on lines 2 to 13 of the dynamic display information 10 shown in FIG. 9 as a definition for one field (1002). The existing technique such as XML parser can be used for parsing the XML document as is the case with the layout information 9.

The dynamic display information acquisition function 3 sets parsed dynamic display information for each field to the control function 4 (1003).

The control function 4 sets a field display attribute in accordance with the set dynamic display information (1004). Then, operations at the steps 1002 to 1004 are repeated by the number of <field> tags (1005). As a result, the display attribute for each of the fields on the screen is changed, and information required for operation is set relevant to each field.

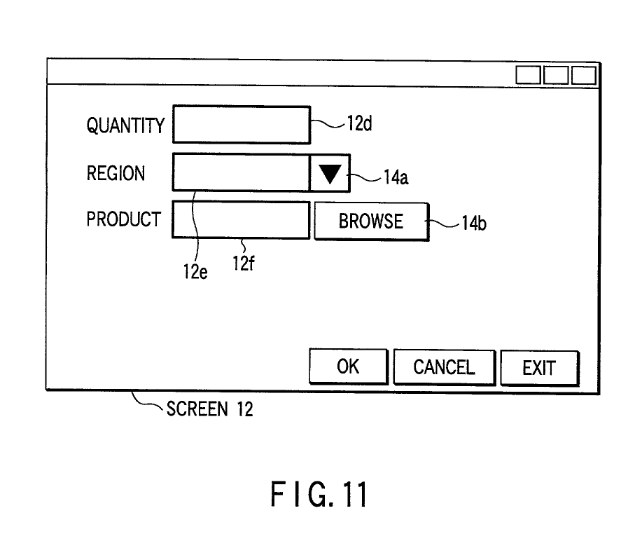

FIG. 11 is a view illustrating a screen configured by a processing of the control function 4 based on the above dynamic display information 10.

On this screen 12, a field 12e whose ID is “area” is a display attribute “COMBO” enclosed in a <state> tag in accordance with the specification on line 3 in the dynamic display information 10 shown in FIG. 9. This display attribute “COMBO” is dynamic display processing identification information indicating a component that enables direct character input to a field. A dynamic display mode as shown in a screen element 14a is employed by specifying a display attribute such as COMBO.

In addition, a field 12f whose ID is “product” is a display attribute “POPUP” in accordance with the specification on line 15 in the dynamic display information 10 shown in FIG. 9. This “POPUP” is dynamic display processing identification information indicating a component accompanying a button to be pressed when a popup window is displayed in a field. By specifying the display attribute “POPUP”, a dynamic display mode as shown in the screen element 14b is employed. Processing for each display attribute set relevant to this field will be described later.

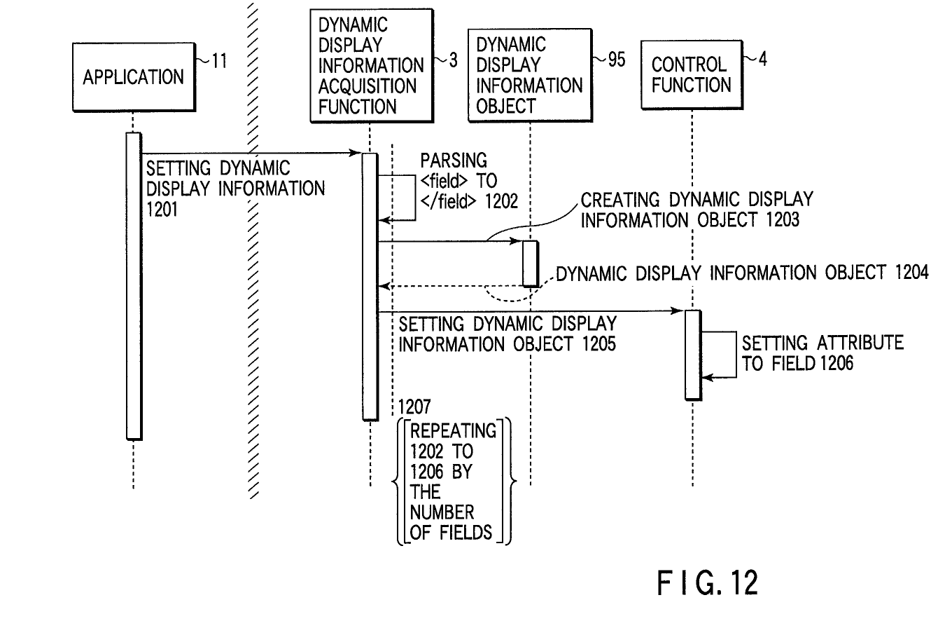

FIG. 12 is a sequence chart showing a modified example of processing procedures when the screen control program 1 reads dynamic display information 10.

In this modified example, an application 11 sets dynamic display information to a dynamic display information acquisition function 2 (1201), and parses <field> to </field> as a definition for one field (1202).

Next, the dynamic display information 3 creates a dynamic display information object 95 having dynamic display information for one field stored therein (1203, 1204), and sets this dynamic display information object 95 to the control function 4 (1205).

The control function 4 sets an attribute to a field (1206).

Then, operations similar to the steps 1202 to 1206 are repeated by the number of fields (1207).

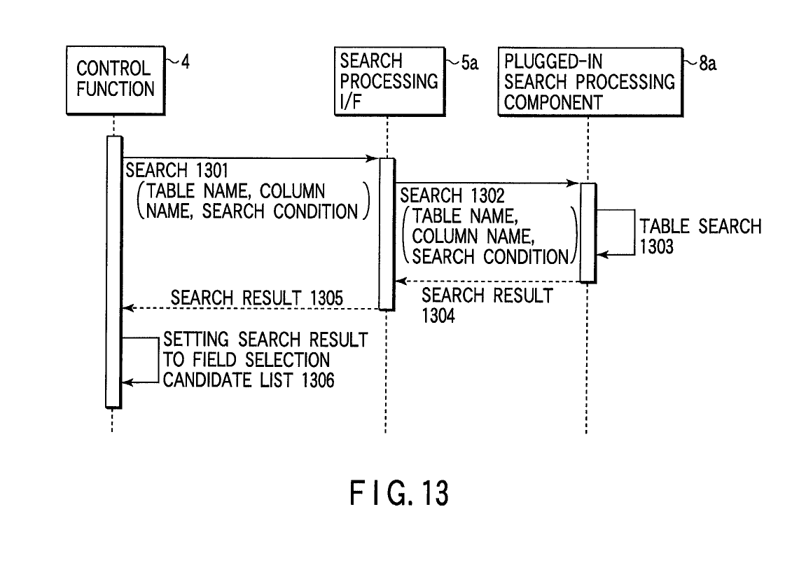

FIG. 13 is a sequence chart illustrating processing procedures executed by the screen control program 1 when the display attribute set relevant to the field is “search”.

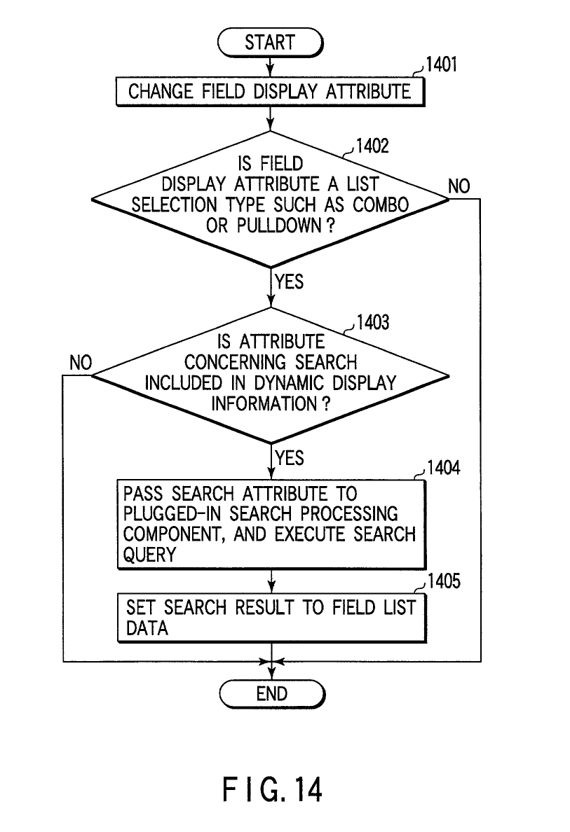

FIG. 14 is a flow chart illustrating processing of the screen control program 1 when the display attribute set relevant to the field is “search”.

When dynamic display information 10 is set relevant to the control function 4, the control function 4 changes the field display attribute for each field (1401).

The control function 4 judges whether or not a list selection COMBO or PULLDOWN is made (whether or not the above attribute is dynamic display processing identification information relevant to search) (1402).

In the case where a field display attribute makes a list selection, the control function 4 judged whether or not an attribute (display attribute information) required for searching data stored in a list is present in dynamic display information (1403).

In the case where the above attribute required for search is present, the control function 4 passes search attributes such as table name, column name to be searched and search conditions to the search processing interface 5a, and supplies a search instruction (1301).

The search processing interface 5a performs search processing by using the plugged-in search processing component 8a (1302). The plugged-in search processing component 8a uses the passed search attributes, and searches for a database or file table based on mounting the component itself (1303, 1404).

The search processing component 8a passes the search result via the search processing interface 5a(1304) to the control function 4 (1305), and stores it as field list data (1306, 1405).

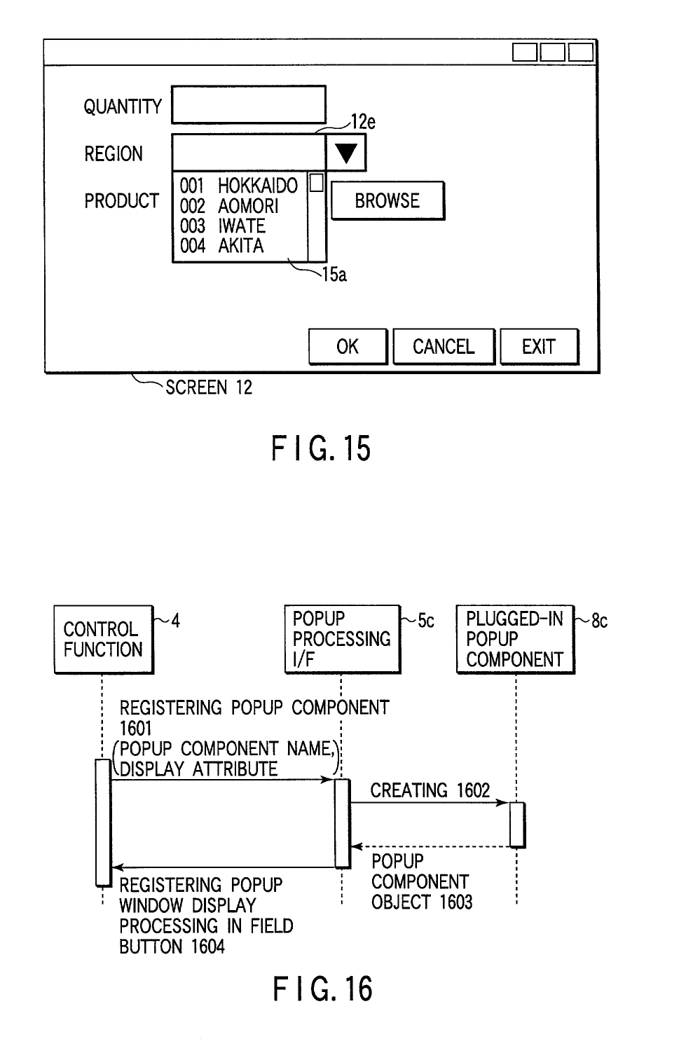

As a result of the above processing, as shown in FIG. 15, the search processing component 8a acquires dynamic display contents. The field 12e of the screen 12 displays a list 15a searched based on a user operation.

FIG. 16 a sequence chart illustrating processing procedures executed by the screen control program 1 when the display attribute set relevant to the field is “popup”.

When dynamic display information is set relevant to the control function 4, the control function 4 changes a field display attribute as is the case with search processing. In addition, the control function 4 judges whether or not the field display attribute indicates “popup” (whether or not the attribute is dynamic display processing identification information relevant to popup). For example, the POPUP specified on line 15 in the dynamic display information 10 shown in FIG. 9 is a display attribute indicating “popup”.

When the display attribute is “popup”, the control function 4 passes to the popup processing interface 5cattributes (display attribute information) such as component name displayed on the popup window, title displayed at a title bar section of a popup window, size and label name of button accompanying the popup window, and instructs registration of the popup processing 8c (1601).

The attribute to be passed to the popup processing interface 5c can be defined so as to be described on lines 18 to 22 dynamically as shown in FIG. 9.

The popup processing interface 5c creates a plugged-in popup component 8c, and acquires an instance (1602, 1603). In addition, the popup processing interface 5c registers in the control function 4 display processing of the acquired popup component 8cas processing activated as a result of field operation (1604). This can be accomplished by executing processing for registering in a button a module activated by an event when the button is pressed, in an example of Java language.

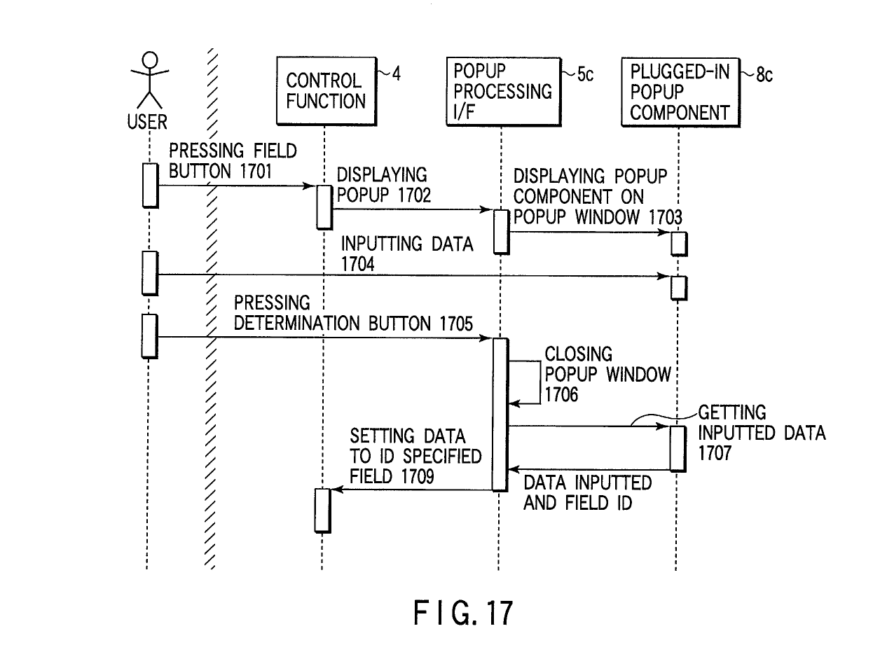

FIG. 17 is a sequence chart illustrating procedures for popup processing activated by a user field operation.

The user makes an operation for instructing a popup display to a field displayed by the control function 4 (1701).

The control function 4 instructs a popup window display to the popup processing interface 5c (1702).

The popup processing interface 5c displays the plugged-in popup processing component 5c on a window (1703).

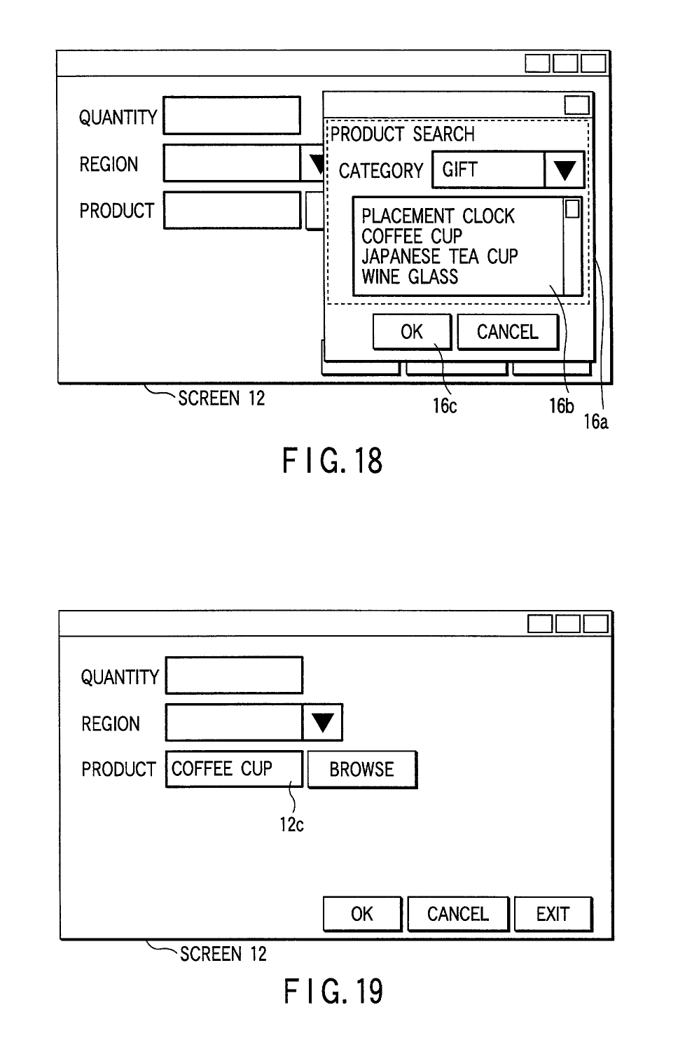

A specific example of the screen in this state is shown in FIG. 18. An element 16s of the screen 12 in FIG. 18 is a plugged-in popup processing component 8c.

Here, the component waits for the user input operation, and the user inputs data to the popup window (1704). In an example shown in FIG. 18, a selecting operation in a screen element 16b corresponds to this input operation.

When the user makes a determining operation such as user pressing the determination button accompanying the popup window (1705), the popup processing interface 5c closes the popup window (1706).

The determination button accompanying the popup window is a button preserved for operation oriented to the popup window itself like the screen element 16c in FIG. 18.

The popup processing interface 5c issues an instruction for acquiring user inputted data to the plugged-in popup processing component 8c (1707).

As a result, the popup processing component 8creturns the ID and value of the inputted data to the popup processing interface 5c (1708). The data ID used here is required in accordance with rules between the popup processing interface 5c and the popup processing component 8c. This ID is identical to an ID assigned to an arbitrary field of the control function 4.

The popup processing interface 5c searches for a field for displaying the obtained data by key inputting the data ID, and sets the ID in the corresponding field of the control function 4 (1709).

A specific example of the screen in this state is shown in FIG. 19. In the field 12c of the screen 12 in FIG. 19, the user selected data on the popup window is set and displayed.

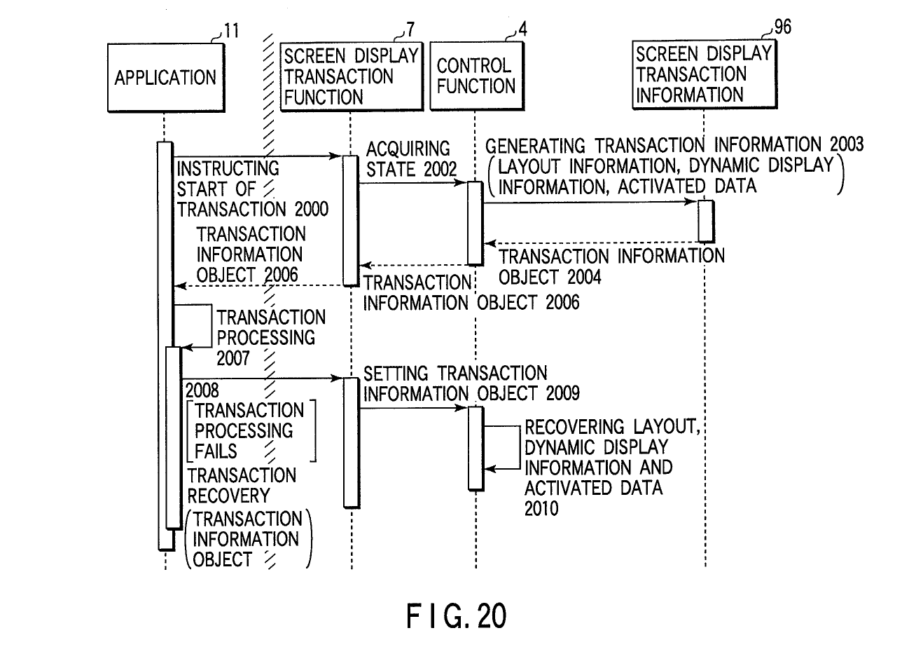

FIG. 20 is a sequence chart illustrating processing procedures for restoring screen display by using a screen display transaction function 7.

An application 11 is instructs the start of the screen display transaction to the screen display transaction function 7 (2001).

The screen display transaction function 7 instructs the control function 4 to acquire the current screen state (2002).

The control function 4 creates a screen display transaction information object 96 that stores set layout information, set dynamic display information and activated data on each field (2003, 2004). The activated data used here denotes data inputted to a field by the user or data displayed in a field by executing an application.

The control function 4 returns the screen display transaction information object 96 to a screen display transaction function 7 (2005).

The screen display transaction function 7 returns the screen display transaction information object 96 to the application 11 (2006).

At this time, the screen display transaction information object 96 manages layout information, dynamic display information and activated data as shown in Table 1.

TABLE 1

| | |
|---|---|
| LAYOUT INFORMATION | LAYOUT INFORMATION |
| | OBJECT |
| DYNAMIC DISPLAY | DYNAMIC DISPLAY |
| INFORMATION | INFORMATION OBJECT |
| ACTIVATED DATA | ACTIVATED DATA LIST |
| | OBJECT |

Instead of returning the screen display transaction information object 96 itself, the screen display transaction information object 96 is managed to be associated with a specific ID by the screen display transaction function 7 or control function 4 so that only ID may be returned to the application 11.

Then, the application 11 continues transaction processing (2007). In the case where transaction processing fails, which requires screen recovery, this application instructs the screen display transaction function 7 to recover transaction (2008). At this time, the application 11 passes to the screen display transaction function 7 the screen display transaction information object 96 or an ID indicating screen display transaction function 96, and instructs recovery.

The screen display transaction function 7 set relevant to the control function 5 the passed screen display transaction information object 96 or an ID indicating the screen display transaction information object 96, and instructs state recovery (2009).

When the screen display transaction information object 96 is set, the control function 4 recovers the screen state to an arbitrary state including a state at a time when transaction is started, based on the layout information, dynamic display information and activated data from the screen display transaction information object 96 (2010). Alternatively, when an ID indicating the screen display transaction information object 96 is set, the control function 4 searches for the screen display transaction information object 96 from such ID. Then, this control function recovers the screen state in accordance with the procedures similar to the above.

As has been described above, by using the screen control program 1 according to the present embodiment, the developer specifies dynamic display processing preserved for acquiring this dynamic display contents with respect to the display contents which are dynamically changed every time a display is requested. In addition, a program for displaying dynamic display contents on the screen can be created merely by specifying an attribute used for acquiring the dynamic display contents.

Therefore, even in the case of developing and changing a screen program whose display contents are changed, there is no need to describe or compile a program.

Hence, the developer can develop a screen program easily and efficiently, and can reduce a development work load.

In addition, by using the screen control program 1 according to the present embodiment, in the case where normal input contents are maintained, and the application 11 is recovered from its failure, the normal input state before a failure occurs can be reproduced on the screen.

Therefore, the user may not make screen re-input, enabling efficient input operation. In addition, the developer can develop such screen program for making input operation efficient easily.

The present embodiment describes a case in which the screen control program 1 comprises a screen display transaction function 7. However, the mount mode of the screen display transaction function 7 is not limited to the above. For example, there may be employed a mode for plugging in a component for executing a screen display transaction function.

In addition, in the present embodiment, the layout information acquisition function 2 and dynamic display information acquisition function 3 acquire and convert layout information 9 and dynamic display information 10 respectively during screen display, and provide the conversion result to the control function 4. In place of this function, however, the layout information acquisition function 2 and dynamic display information acquisition function 3 acquire and convert in advance the layout information 9 and dynamic display information 10 respectively so that the control function 4 may read the converted information during screen display.

(Second Embodiment of the Invention)

A second embodiment describes a screen control program for setting layout information to be divided into several sections.

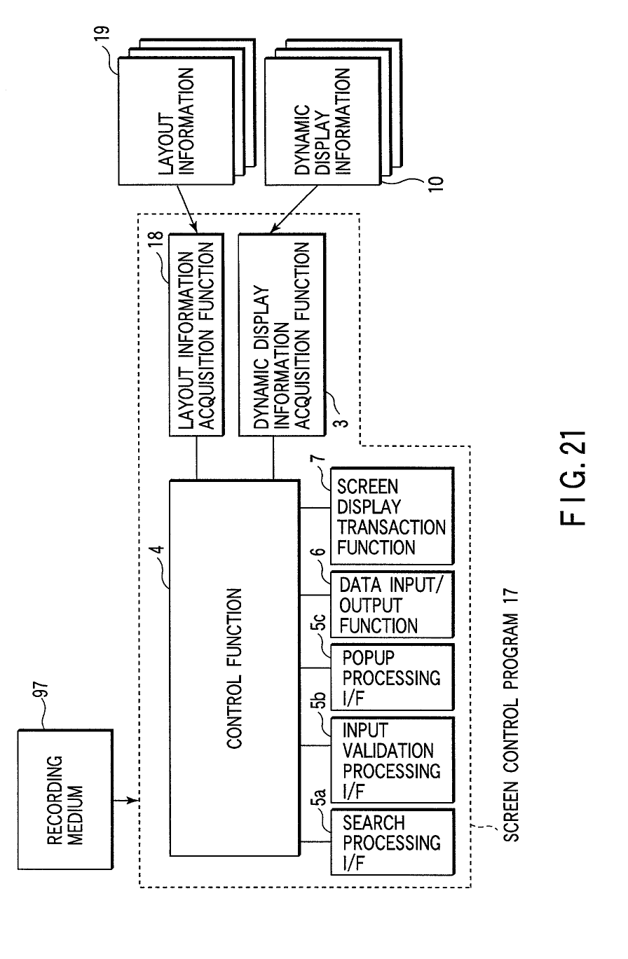

FIG. 21 is a block diagram depicting a function executed on a computer by a screen control program according to the present embodiment.

A layout information acquisition function 18 in this screen control program 17 corresponds to a case in which layout information is set relevant to be divided into several sections. This layout information acquisition function 18 inputs layout information 19 divided in plurality.

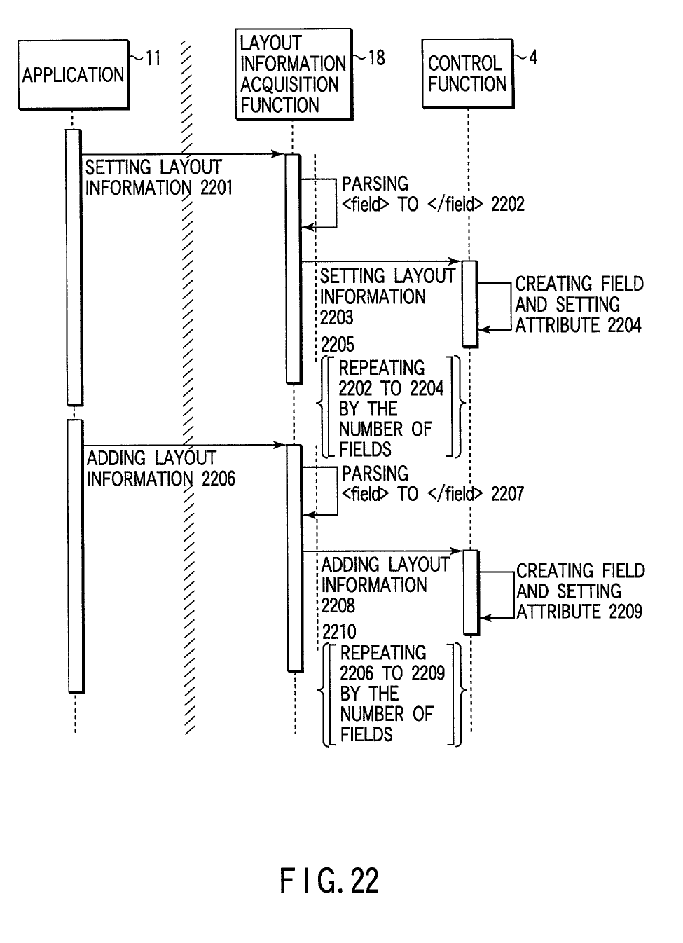

FIG. 22 is a sequence chart illustrating processing procedures when the screen control program 17 according to the present embodiment reads layout information.

The steps 2201 to 2205 are similar to the steps 301 to 305 in FIG. 3. Layout information is set relevant to the control function 4 in accordance with these steps, and a field is displayed on the screen in its initial state.

Next, another divided layout information is specified, and the application 11 supplies an instruction for adding the layout information to a layout information acquisition function 18 (2206).

The layout information acquisition function 18 parses field attribute information in accordance with procedures similar to the step 2202 (2207), and instructs the control function 4 to add layout information (2208).

The control function 4 creates an object of the added field, and sets an attribute (2209). Then, the steps 2207 and 2208 are repeated by the number of added fields (2210). This makes it possible to initialize a layout as required.

With the dynamic display information acquisition function 3 as well, like this layout information acquisition function 18, it may be possible to read dynamic display information 10 to be divided into several sections.

An advantageous effect similar to that according to the first embodiment can also be achieved by using the screen control program 17 according to the present embodiment.

(Third Embodiment of the Invention)

A third embodiment describes a screen control program used in environment in which layout information and dynamic display information are allocated over a network.

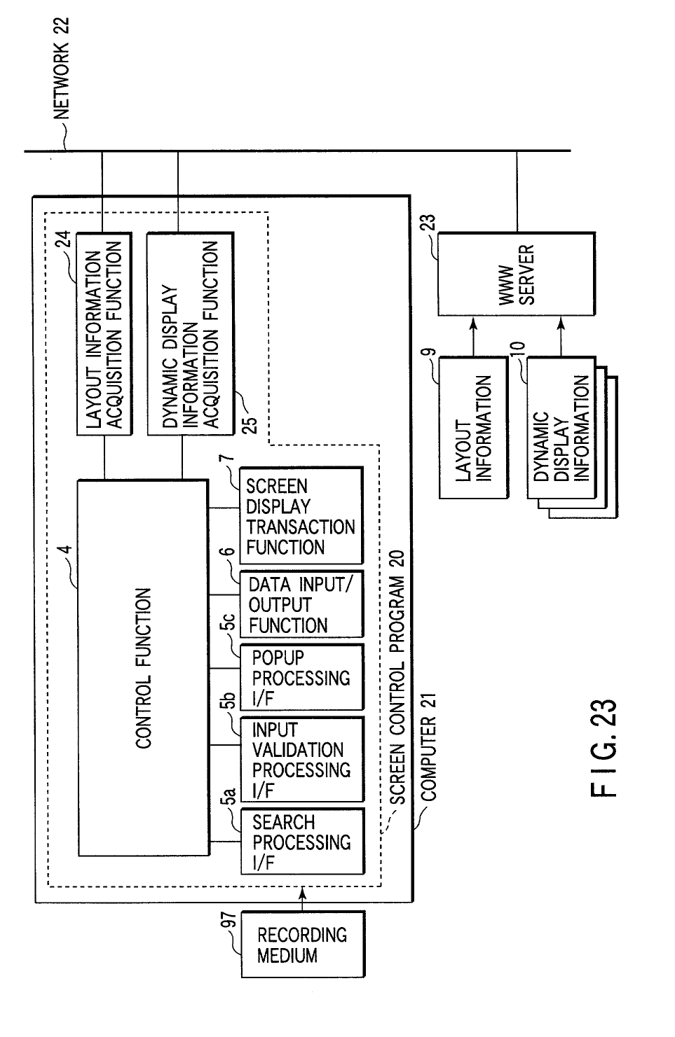

FIG. 23 is a block diagram illustrating a function executed on a computer system by the screen control program according to the present embodiment.

A computer 21 comprising a screen control program 20 is connected to a WWW server via a network 22.

A layout information acquisition function 24 downloads layout information 9 via the network 22.

A dynamic display information acquisition function 25 downloads the dynamic display information 10 via a network 22.

The WWW server 23 is a specific example of a server process that enables a download of layout information 9, dynamic display information 10.

In the case where the layout information 9 is downloaded via the network 22, URI (Uniform Resource Identifiers) of the layout information 9 is specified at the step 301 shown in FIG. 3.

The layout information acquisition function 24 establish a connection to the URI specified by providing access to the WWW server 23, and reads the layout information 9.

In the case where the dynamic display information 10 is downloaded via the network 22, such download is performed similarly when the layout information 9 is downloaded. Then, the URI of the dynamic display information 10 is specified at the step 1001 shown in FIG. 10.

A class handing a file specified by the URI is provided in a Java language. The above operation can be made by using this class.

An advantageous effect similar to that according to the first embodiment can also be achieved by using the screen control program 20 according to the present embodiment.

(Fourth Embodiment of the Invention)

A fourth embodiment describes a screen control program used in environment in which the components plugged in each interface are dispersed over a network.

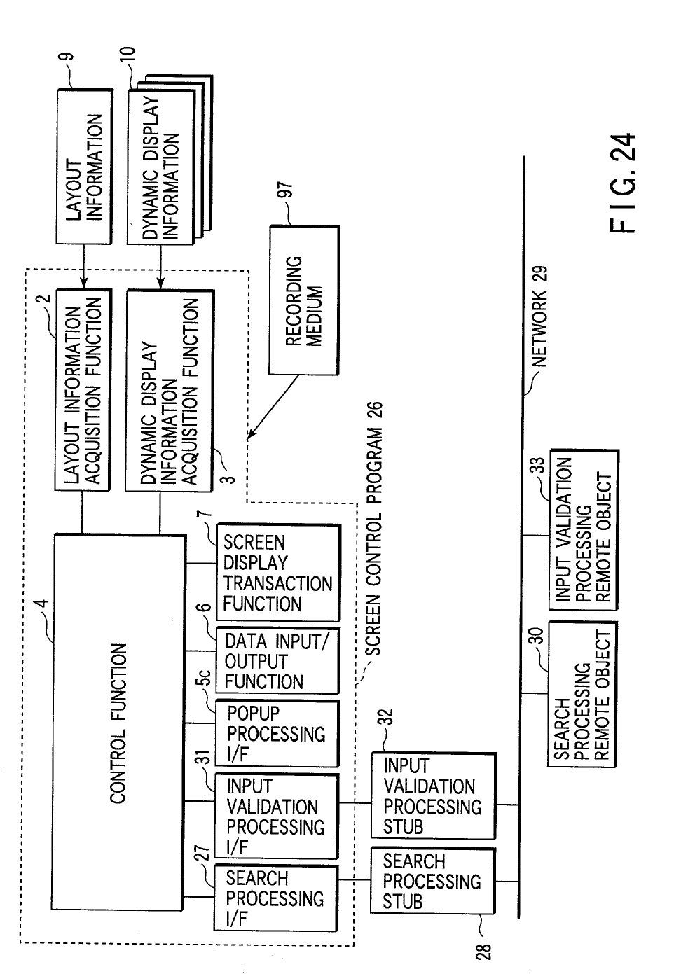

FIG. 24 is a block diagram depicting a function executed on a computer system by the screen control program according to the present embodiment.

A screen control program 26 operates on a computer. A search processing interface 27 in the screen control program 26 is connected to a search processing stub 28.

This search processing stub 28 is a search processing component plugged in the search processing interface 27. The search processing stub 28 requests a search processing remote object 30 to perform search processing via a network 29, receives the result of the search processing performed by the search processing remote object 30, and returns it to the search processing interface 27.

Similarly, an input validation processing interface 31 is connected to an input validation processing stub 32.

This input validation processing stub 32 is an input validation processing component plugged in the input validation processing interface 31. The input validation processing stub 32 requests an input validation processing remote object 33 to perform input validation processing via a network 29, receives the result of the input validation processing performed by the input validation processing remote object 33, and returns it to the input validation processing interface 31.

An advantageous effect similar to that according to the first embodiment can be achieved by using the screen control program 26 according to the present embodiment.

(Fifth Embodiment of the Invention)

A fifth embodiment describes a screen control program in which screen display transaction information is maintained in a server, and the server is used for controlling a client screen state.

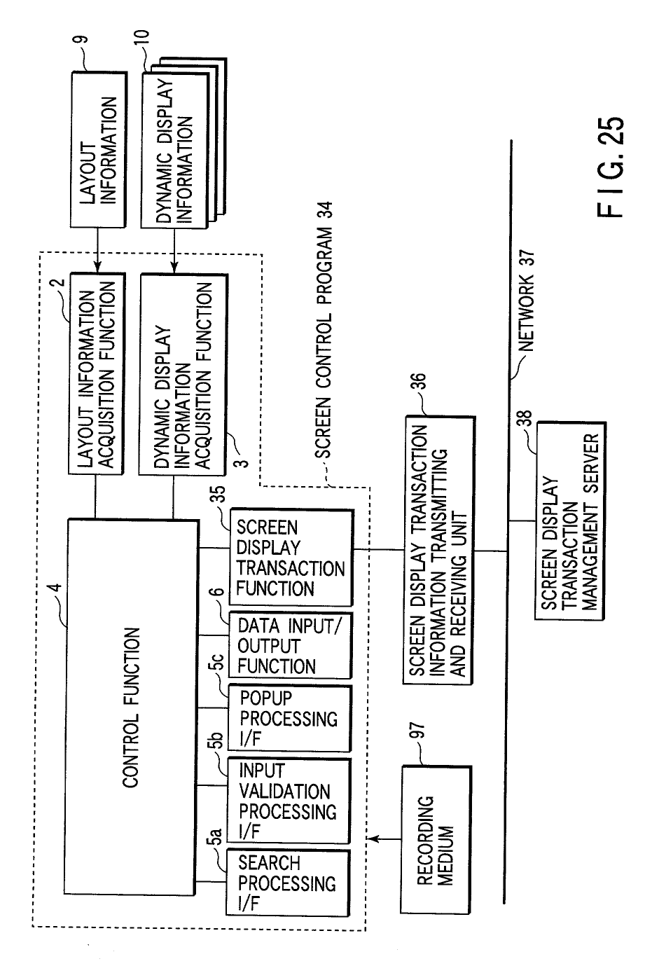

FIG. 25 is a block diagram depicting a function executed on a computer system by the screen control program according to the present embodiment.

A screen control program 34 operates on a client's computer system. A screen display transaction function 35 in the screen control program 34 is connected to a screen display transaction information transmitting and receiving unit 36.

The screen display transaction information transmitting and receiving unit 36 acquires screen display transaction information (screen state information) from the screen display transaction function 35, and transmits the information to a screen display transaction management server 38 via a network 37.

In addition, the screen display transaction information transmitting and receiving unit 36 sets to the screen display transaction function 35 the screen display transaction information received from the screen display transaction management server 38.

The screen display transaction management server 38 manages the screen display transaction information received from the screen display transaction transmitting and receiving unit by client.

Then, the screen display transaction management server 38 fetches the managed screen display transaction information as required, and transmits the fetched information to the screen display transaction information transmitting and receiving unit 36.

An advantageous effect similar to that according to the first embodiment can also be achieved by using the screen control program 34 according to the present embodiment.

(Sixth Embodiment of the Invention)

A sixth embodiment describes a screen control program for plugging in transaction processing.

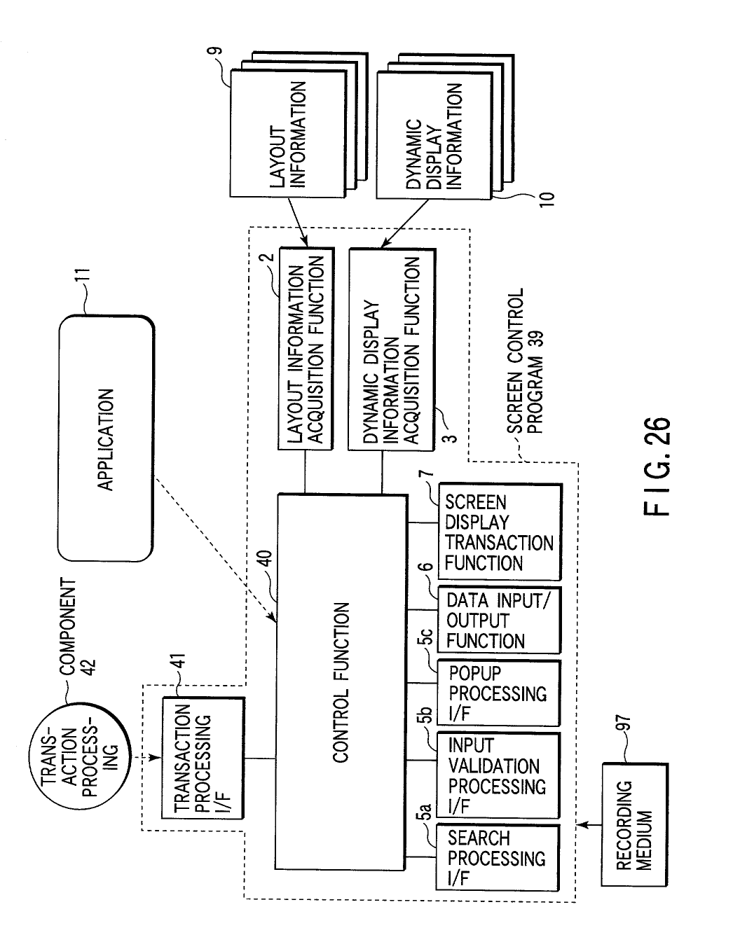

FIG. 26 is a block diagram depicting a function executed on a computer by the screen control program according to the present embodiment.

A control function 40 of a screen control program 39 is connected to a transaction processing interface 41.

A transaction processing component (a variety of programs) 42 is plugged in the transaction processing interface 41 by using a technique similar to that used for a component concerning another screen display.

An application 11 can execute transaction processing as well as processing concerning screen display by using this screen control program 39.

When a developer wants to use this transaction processing component 42, the developer may specify the component 42, and specify a required attribute merely like a component concerning another screen display.

In this manner, application development as well as screen program development can be made efficient.

The subject matters described in each of the above embodiments can be freely combined with each other. In addition, the location of functions and elements described in each of the above embodiments may be changed as long as the similar effect and functions can be achieved, and the functions and elements may be freely combined with each other.

The functions and elements of the screen control program described in each of the above embodiments are programs that can be executed by a computer. These programs can be applied to a computer by writing them into a recording medium 97 such as magnetic disk (such as floppy disk or hard disk), optical disk (such as CD-ROM or DVD), or semiconductor memory, for example. In addition, these programs can be applied to a computer or computer system by transmitting them by means of a communication medium.

A computer for executing functions of the screen control program described in each of the above embodiments reads programs recorded in a recording medium, and operation is controlled by these programs, thereby executing the above described processing.

(Seventh Embodiment of the Invention)

A seventh embodiment describes how a screen is actually changed by inputting dynamic display processing identification information and display attribute information.

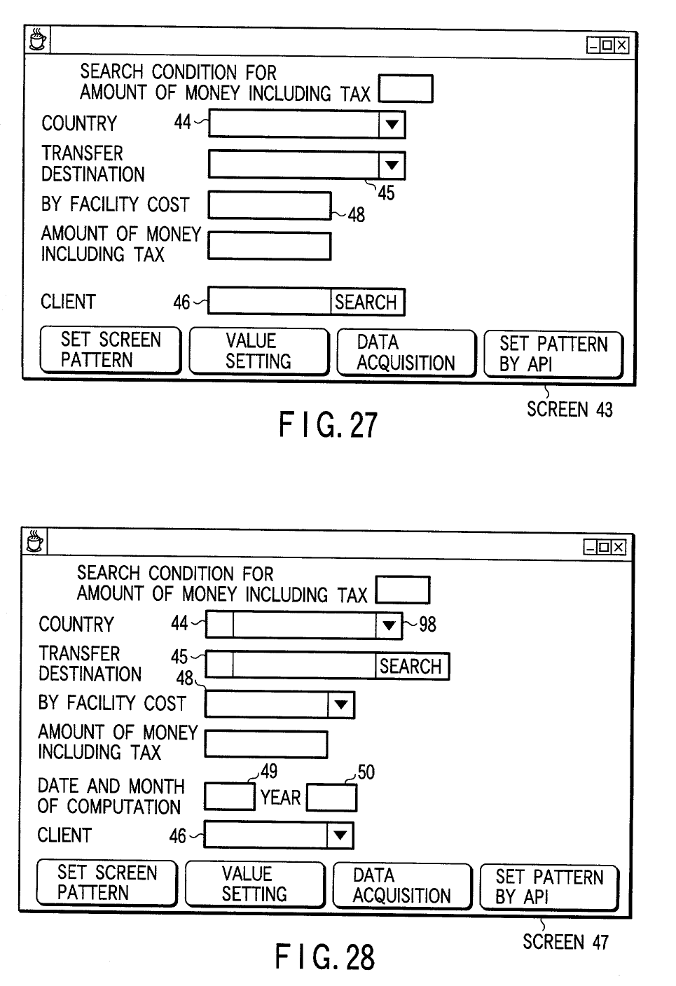

FIG. 27 is a view illustrating a configuration of a screen before changed.

A display attribute in which a pull-down menu is made available is initially set relevant to a “country” field 44 and a “transfer destination” field 45 that are constituent elements of this screen 43.

On the other hand, in a “client” field 46, a display attribute in which a popup search is made available is initially set.

FIG. 28 is a view illustrating a configuration of a screen after changed by inputting dynamic display processing identification information and display attribute information.

On this screen 47, a dynamic display attribute in which a combo box is made available is set relevant to the “country” field 44. Further, on the screen 47, a search processing component 8a and an input validation processing component 8b are newly plugged in.

The developer inputs dynamic display processing identification information describes the fact that the search processing component 8a and the input validation processing component 8b are plugged in relevant to the “country” field 44. In addition, the developer inputs display attribute information (dynamic display attribute information) describing the fact that it is validated whether or not the input contents are composed of four-digit numerals and one or more characters.

In this manner, an input validation of the “country” field 44 can be easily performed.

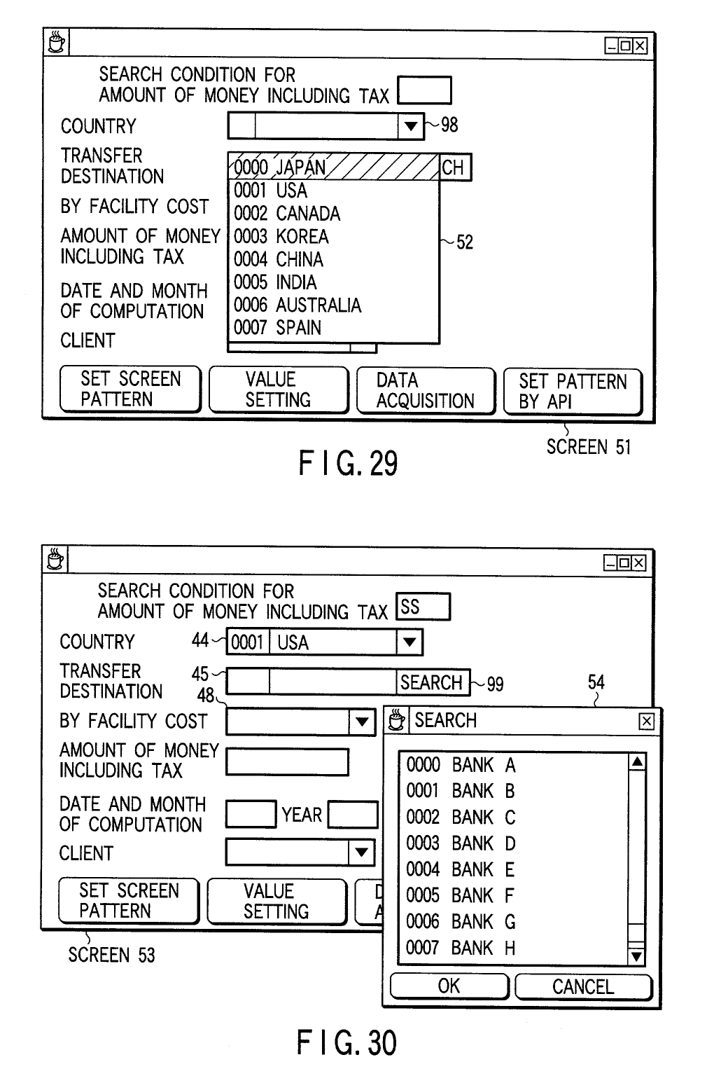

In addition, a database is searched for by pressing a list display button 98 in the “country” field 44, and a list 52 of search results as shown in FIG. 29 is displayed. Then, a user selection from such list is acceptable.

On the screen 47, the input validation processing component 8b is plugged in relevant to the “transfer destination” field 45 in the similar manner. In addition, the display attribute information (dynamic display attribute information) relevant to this component 8b is also inputted.

Further, a popup processing component 8c is plugged in relevant to this “transfer destination” field 45. For the display attribute information relevant to this popup processing component 8c, a class configuring a screen to be displayed on the popup window is specified.

Furthermore, in the “client” field 46 on this screen 47, a display attribute in which a pull-down menu is made available is set instead of the display attribute in which a popup search is made available. In addition, the search processing component 8a is also plugged in relevant to this field 46.

Still furthermore, on the screen 47, a display attribute in which the pull-down menu is made available is set relevant to a “by facility cost” field 48 as in the above “client” field 46, and the search processing component 8a is plugged in. In addition, on this screen 47, a “year and month of computation” field 49 and a “year” field 50 are added. In the fields 49 and 50, a display attribute on which these fields are made available as text fields is set.

FIG. 30 is a view illustrating a state of a screen on which a popup processing component 8c is plugged in relevant to the “transfer destination” field 45 is activated.

On the screen 53, when a search button 99 of the “transfer destination” field 45 is pressed, a popup window 54 is displayed. The search result is displayed on this popup window 54.

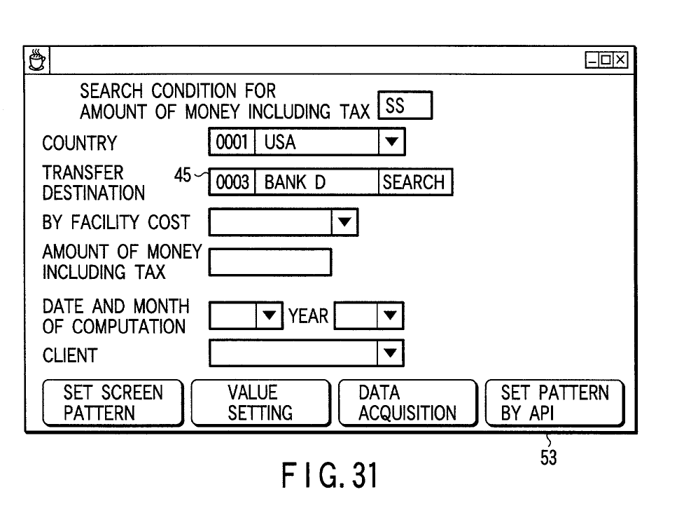

FIG. 31 is a view illustrating a state of a screen 53 on which selection of the search results is made.

When any element of the search results is selected by a user, a popup window 54 is closed, and a value selected for the “transfer destination” field 45 is automatically set.

(Eighth Embodiment of the Invention)

An eighth embodiment defines an interface for exchanging data between GUI components configuring a screen.

The present embodiment describes an interface for exchanging data between a GUI component and a custom component such as programs or data applied to this GUI component.

The GUI component denotes a screen component for achieving a user interface.

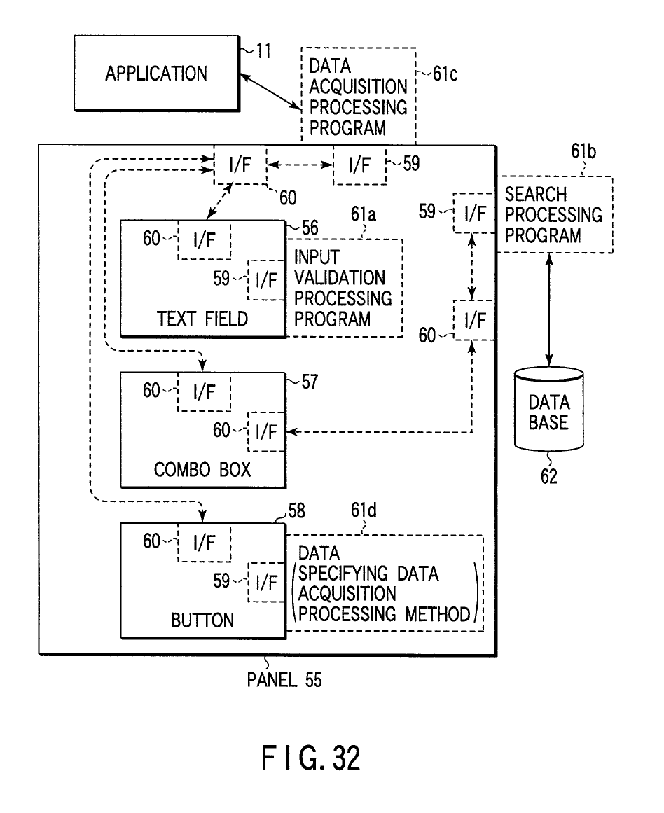

FIG. 32 is a block diagram illustrating a data exchange state caused by an interface function of the GUI component according to the present embodiment.

The GUI component configuring a screen has a program at a portion that does not depend on applications.

In addition, the GUI component has a hierarchical relation. A management type component operates as a parent of other GUI components. A managed type component operates on the management type component.

In FIG. 32, a panel 55 is a management type component. A text field 56, a combo box 57 and button 58 are managed components.

The present embodiment defines in advance an interface between GUI components and an interface between the GUI component and the custom component.

That is, the management type component and the managed type component have an interface function 59 for exchanging data with a custom component mounted thereon. In addition, the management type component and managed type component have an interface function 60 for exchanging data with another GUI component.

Further, in the management type component and the managed type component, there are defined in advance as a framework basic operation portions of the GUI component such as requesting execution of input a validation processing after key input; when a condition for acquiring a list is set, requesting search; receiving and displaying the search result; and calling a program when a button is pressed. In this manner, the basic operation portions of the GUI component are part of the GUI component.

A custom component mounted on the GUI component includes programs or data at a portion that does not depend on applications. The programs depending on this application include, for example, an input validation processing program 61a, a search processing program 61b, and a data acquisition processing program 61c or the like.

On this screen, the input validation processing program 61a receives a request for executing an input validation processing from the text field 56 by using the interface function 59 and the interface function 60, and executes the input validation processing, and performs operations in accordance with the result.

The search processing program 61b receives a request for searching from a combo box 57 by using an interface function 60, executes search for a predetermined database 62 based on the contents of this request, and returns the search result to the combo box 57 by using the interface function 59.

A data acquisition processing program 61c acquires input contents on the panel 55 by using the interface function 59 when the program is called.

Data 61d is read by the application 11 by using the interface function 59 when a button 58 is pressed.

For example, when the button 58 is pressed, the button 58 reads the data 61d mounted on its own by using the interface function 59. The data 61d specifies a method of the data acquisition processing program 61c.

Then, the button 58 calls the data acquisition processing program 61c by using an interface function 60 between the GUI components.

When the data acquisition processing program 61c is called, the program 61c uses the interface function 59 and the interface function 60, and acquires data inputted in the text field 56. Further, when the program 62c uses the interface function 59 and the interface function 60, and acquires data inputted from the combo box 57.

The data acquisition processing program 61ctransmits acquired data to the application 11.

Now, procedures for creating a screen program by using the GUI component and custom component according to the present embodiment will be described below.

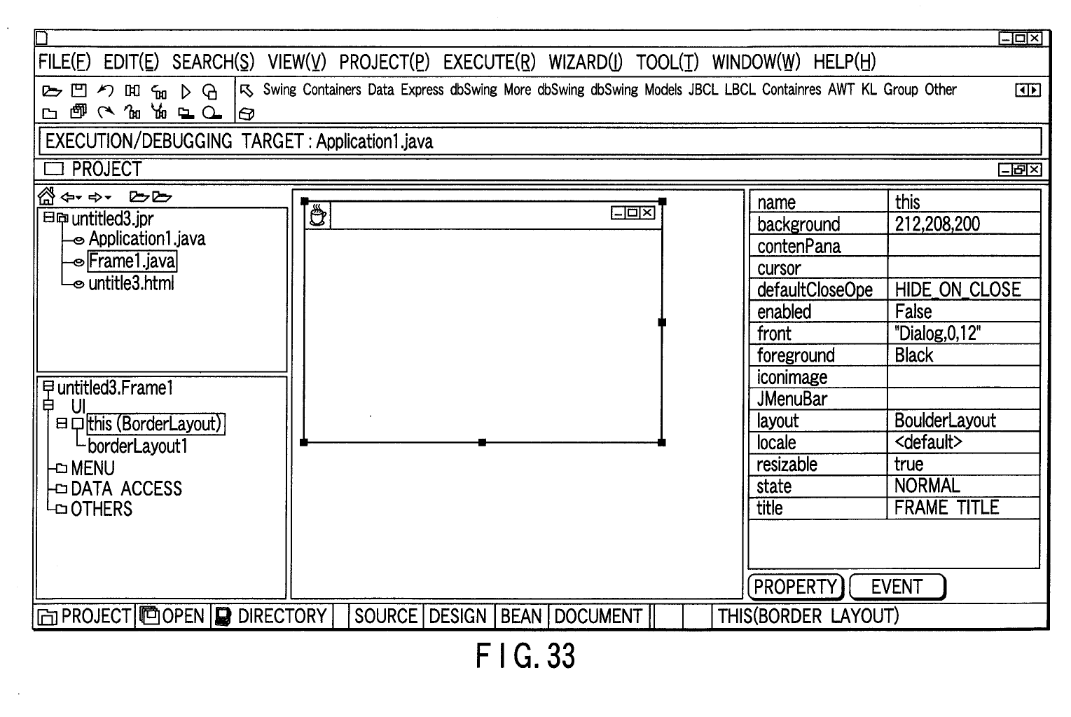

First, a screen creating tool is activated. The activated screen creating tool displays an initial screen as shown in FIG. 33.

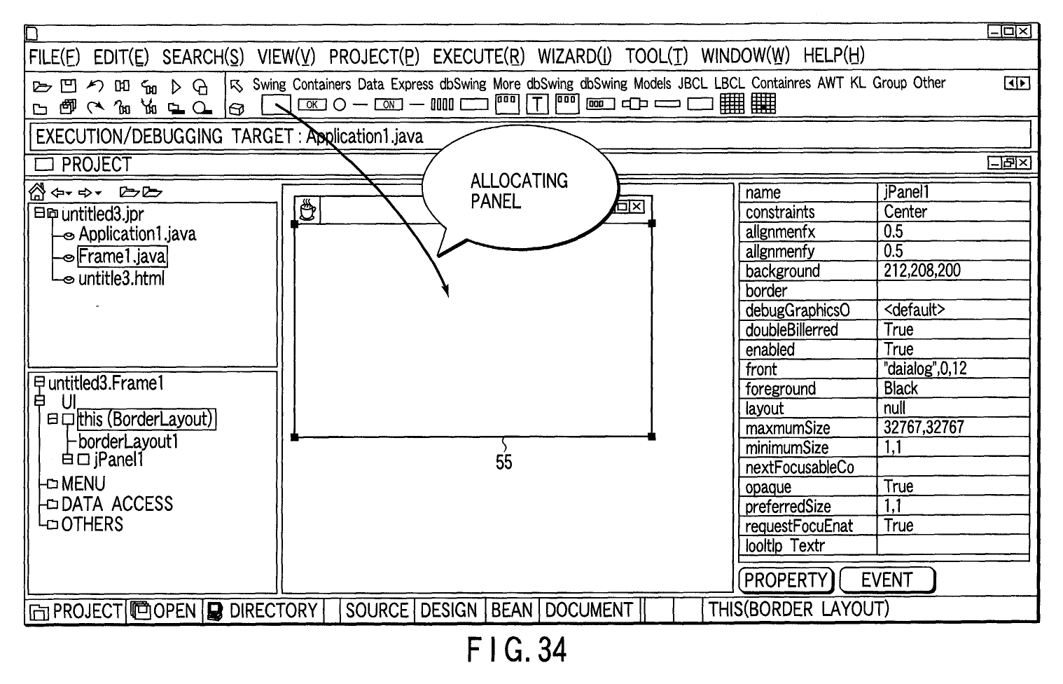

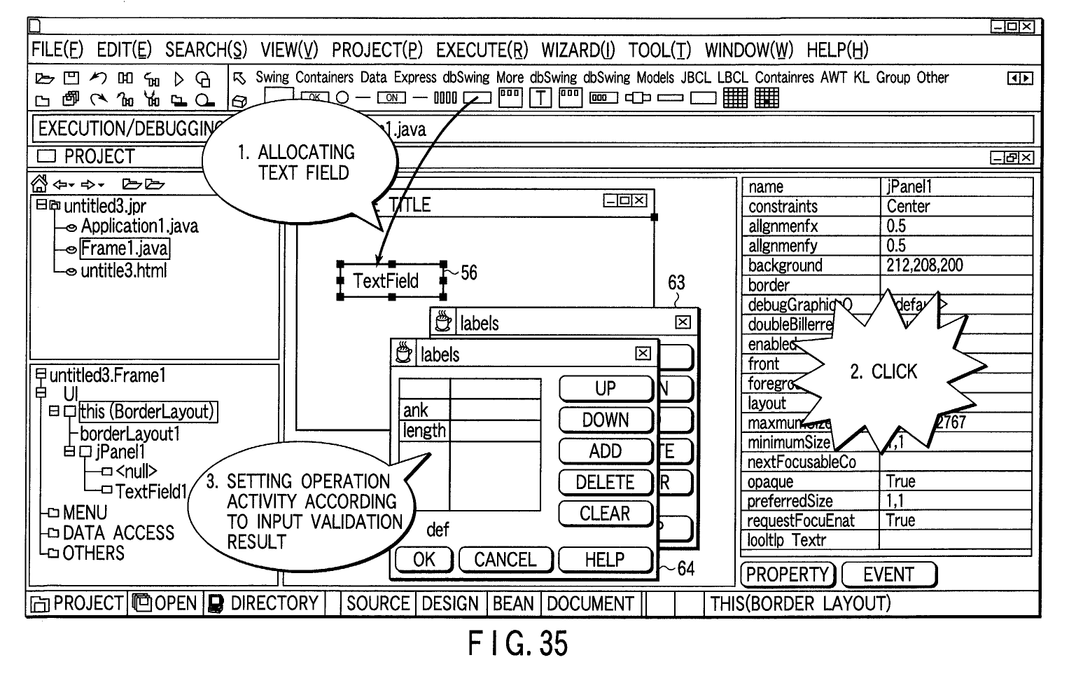

For example, the developer makes an operation for allocating a panel 55, as shown in FIG. 34. Then, the developer allocates a text field on the panel 55, as shown in FIG. 35.

Then, a window 63 is displayed, the window listing custom components mountable on the text field 56.

Here, assume that the developer specifies an input validation processing program 61a on this window 63.

Then, a window 64 for setting an attribute of an input validation processing program is displayed as a property of this text field 56.

The developer sets an attribute of operation according to the input validation result on this window 64.

As has been described above, in the present embodiment, there is provided a technique for creating a screen program by combining the GUI component and custom component with each other.

In this way, the developer can create a screen program for performing a variety of operations merely by specifies as an attribute a portion that depends on applications such as the operation according to the input validation rules and validation result or search condition.

Therefore, the developer's work load can be reduced. In addition, an interface is defined, portions configuring a screen is shared by a plurality of developers, and these portions can be combined with each other later.

(Ninth Embodiment of the Invention)

A ninth embodiment specifically describes the GUI component and custom component according to the eighth embodiment.

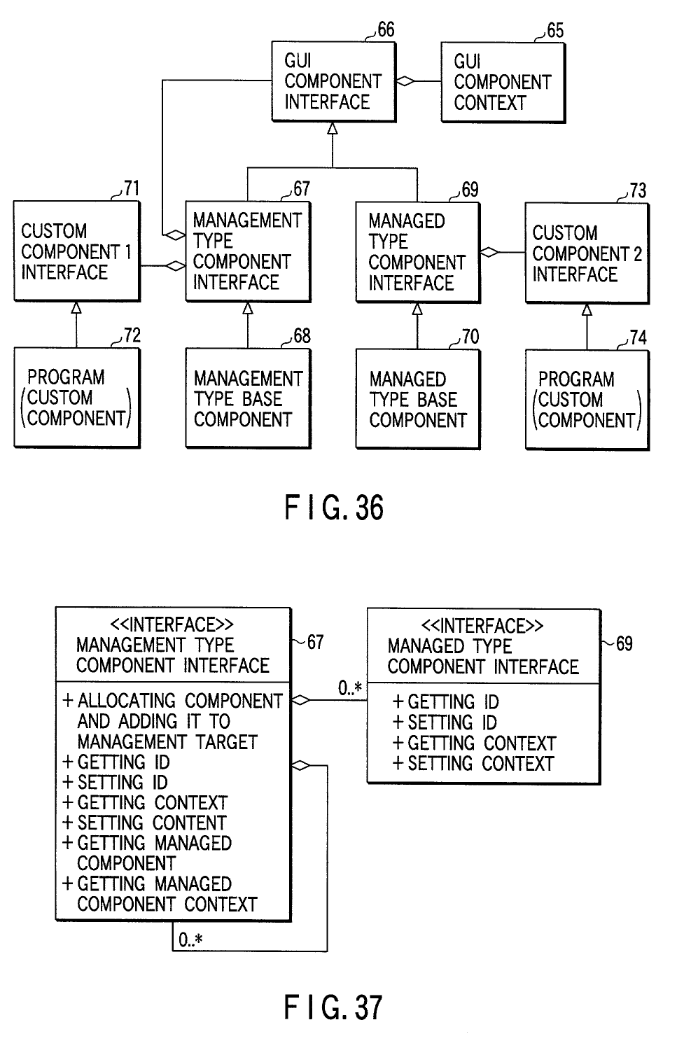

FIG. 36 is a class chart illustrating a configuration of the GUI component and custom component.

All GUI components have “GUI component context 65” that is data type handled in common.

All the GUI components are created in accordance with an interface, i.e., “GUI component interface 66” capable of exchanging “GUI component context 65”.

The GUI component include a component capable of allocating another GUI component on its own, such component being defined as a management type component. This component can manage an allocated component. The management type component is created in accordance with “management type component interface 97” for allocating and managing parts by itself. A component created as a GUI component that actually operates in accordance with this interface is “management type base component 68”. This is specifically a GUI component such as panel. The management component can manage another management type component as well.

On the other hand, a component that does not manage another component is defined as a managed type component. This managed type component is created in accordance with “managed type component interface 69” to be managed by a management type component. “Managed type base component 70” is created as a GUI component that actually operates in accordance with this interface.

A description of the components each providing a basic operation portion that do not depend on applications has now been completed.

A portion depending on applications is defined as a removable program called a custom component, and is mounted on a base component that performs basic operations. Through this mounting, an operation depending on applications is added to the basic operations.

The base component and custom component are classified into plural types by its nature, and a correlation between the base component and the custom component is predetermined.

One or more types of custom components can be mounted on a management type component. An interface activated from the base component is determined depending on type of custom component. The interface activated from the base component is defined as “custom component 1 interface 71” in FIG. 36. A program 72 describing a specific operation is created in accordance with this interface.

Similarly, one or more types of custom components can be mounted on a managed component as well. An interface for calling the custom component from the base component is predetermined. This interface is called “custom component 2 interface 73” in FIG. 36. A program 74 describing a specific operation is created in accordance with this interface.

FIG. 37 shows a relationship between a management type component and a managed type component.

Management type component interface 67 is an interface to be owned by the management type component. In a Java language, this interface is defined in the form of “interface”. This “interface defines what operation should be provided to the outside. The management type component interface 67 defines: an operation for allocating a component, and adding the component as a management object; an operation for setting/getting its own ID; an operation for setting/getting a context owned by itself; an operation for acquiring a component targeted for management by defining ID of the component as a key; and an operation for acquiring a context owned by a component targeted for management.

On the other hand, managed type component interface 69 is an interface to be owned by a managed type component. The managed type component interface 69 defines an operation for setting/getting its own ID and an operation for acquiring a context owned by its own.

A relationship between the management type component interface 67 and the managed type component interface 69 is 1 to multiple. In addition, the management type component interface 67 can manage component of type identical to its own, and the relationship is also 1 to multiple.

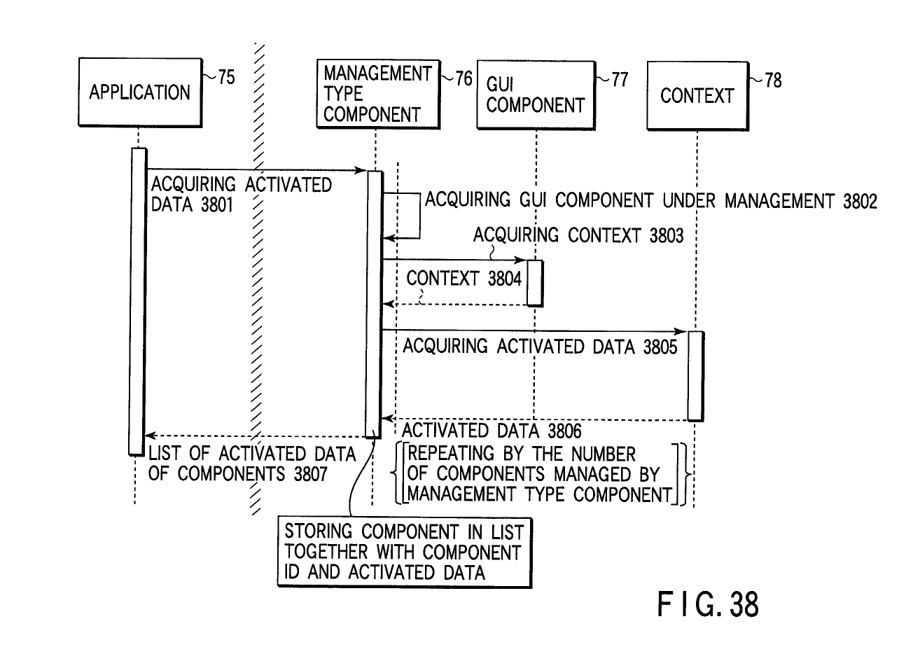

FIG. 38 is a sequence chart illustrating processing procedures between a management type component and a managed type component. The procedures described here are processing procedures for acquiring data inputted/selected by the user. The current data on the screen that an application should acquire is activated data described previously.

An application 75 is an application that uses a screen program created in the present embodiment.

The management type component 76 is a management component instance.

A managed type component 77 is a GUI component allocated and managed on the management type component 76.

A context 768 is a context owned by the GUI component. An application 75 calls processing for acquiring activated data to the management type component 76 (3801).

Then, the management type component 76 acquires a list of GUI components managed by its own (3802).

Then, processing for acquiring a context is called to the GUI components stored in the acquired list (3803). The GUI component 77 returns its own context as a return value (3804).

This context stores activated data on the GUI component, and thus, the management type component 76 calls processing for acquiring activated data to the obtained context (3805).

A context 78 returns activated data as a return value (3806).

The management type component 76 repeats the above processing by its own managed GUI component. Then, the obtained activated data is paired with ID of the component, is listed, and is returned as a return value to an application (3807).

In this way, the application developer can acquire screen data without considering what types of GUI parts are allocated or what processing should be called to fetch a value by GUI parts.

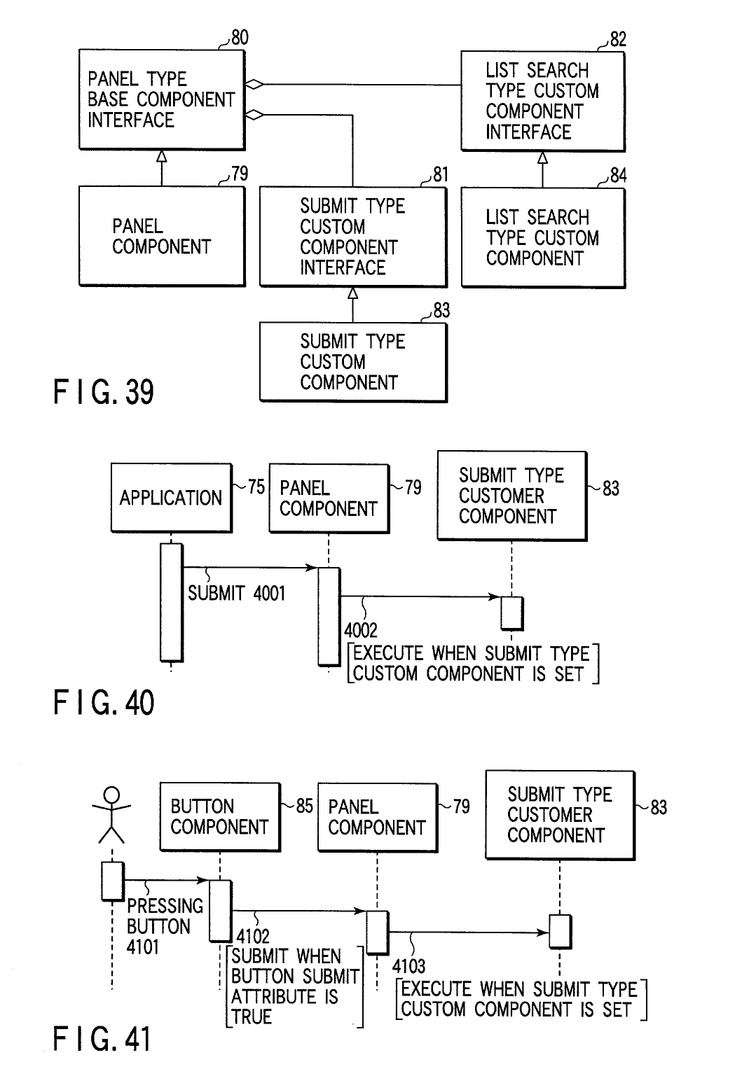

Now, a relationship between a base component and a custom component is shown in FIG. 39 to FIG. 44.

First, an example of a panel component that is a type of management type component is shown below.

FIG. 39 shows a relationship between the base component and custom component in a panel component.

An operation that the panel component provided to the outside is defined as a panel type base component interface 80. The panel component 79 that actually operates is created by mounting a panel type base component interface 80. The base component interface defines what type of custom component is mounted as well. A submit type custom component interface 81 and a list search type custom component interface 82 are mounted on the panel type base component interface 81.

In a specific operation of the custom component, a submit type custom component 83 is created by mounting the submit type custom component interface 81, and a list search type custom component 84 is created by mounting the list search type custom component interface 82.

FIG. 40 to FIG. 42 each show a sequence chart indicating processing when an application makes a submit operation for a panel component.

FIG. 40 is a sequence chart illustrating processing when an application has made a submit operation for the panel component.

An application 75 calls a submit operation for the panel component 79 (4001).

The panel component 79 judges whether or not the submit type custom component 83 is set itself. In the case where the judgment result is affirmative, this component calls an executing operation of the submit type custom component 83 (4002).

FIG. 41 is a sequence chart showing processing when the submit operation of the panel component 79 is performed by defining a user button operation as a trigger.

A button component 85 is a component allocated on the panel component 79.

A user who operates an application presses a button component 79 allocated on the panel component 85 (4101). The button component 85 calls a submit operation of the panel component 79 allocated by itself (4102). The panel component 603 judges whether or not a submit type custom component is set to itself. In the case where the judgment result is affirmative, the executing operation of the submit type custom component 83 is called (4103).

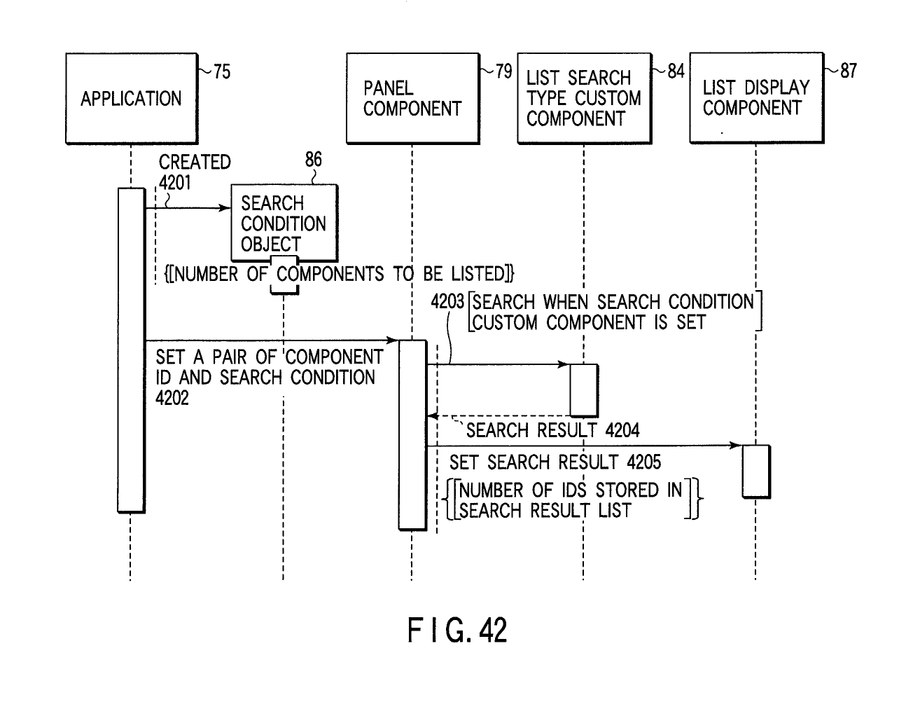

FIG. 42 is a sequence chart illustrating processing procedures between a panel component 79 and a list search type custom component 84.

A search condition object 86 is an object that stores a search condition for searching list data.

A list display component 87 is a GUI component of such type displaying list data allocated on the panel component 79.

The search condition object 86 for storing a condition for a list charge is created by the application 75 (4201). This search condition object 86 is created when a search condition is given. The search condition object 86 is created repeatedly by the number of components for which list data is created.

The application 75 sets the thus obtained search condition to the panel component 79 with a pair of component ID (4202).

The panel component 79 judges whether or not a list search type custom component 84 is set to itself. When the judgment result is affirmative, the component passes the search condition object 86, and calls a search operation of the list search type custom component 84 (4203).

The list search type custom component 84 performs processing for searching a database or a file in accordance with the given search conditions, and returns the search result to the panel component 79 as a return value.

The panel component 79 sets the obtained search result to a list display component 87 whose correlation is defined by ID. Then, the steps 4202 to 4204 are repeated by the number of given condition pairs (4205).

Now, an example of a managed type component is shown below. There are several types of managed type components according to its use, and a relationship between respective types of base components and of custom components is predetermined. An example is shown below in Table 2. Here, an example of a text field component is shown.

TABLE 2

| | | | | LIST | | | |
|---|---|---|---|---|---|---|---|
| | | DATA | | DATA | | | |
| | IMPLEMENTATION | SETTING/ | INPUT | SETTING/ | | | |
| COMPONENT TYPE | OF COMPONENT | GETTING | VALIDATION | GETTING | SEARCH | submit | popup |
| PANEL | PANEL | ◯ | — | ◯ | ◯ | ◯ | — |
| RADIO BUTTON PANEL | RADIO BUTTON | ◯ | — | — | — | — | — |
| | PANEL | | | | | | |
| EXECUTION COMPONENT | BUTTON | ◯ | — | — | — | ◯ | ◯ |
| DISPLAY COMPONENT | LABEL | ◯ | — | — | — | — | — |
| TEXT EDITING | TEXT FIELD | ◯ | ◯ | — | — | — | — |
| COMPONENT | PASSWORD FIELD | ◯ | — | — | — | — | — |
| | TEXT AREA | ◯ | ◯ | — | — | — | — |
| | HTML DISPLAY | ◯ | ◯ | — | — | — | — |
| | AREA | | | | | | |
| FIXED SELECTION | CHECK BOX | ◯ | — | — | — | — | — |
| COMPONENT | RADIO BUTTON | ◯ | — | — | — | — | — |
| | TOGGLE BUTTON | ◯ | — | — | — | — | — |
| SINGLE SELECTION | COMBO BOX | ◯ | ◯ | ◯ | — | — | — |
| LIST COMPONENT | | | | | | | |
| MULTIPLE SELECTION | LIST | ◯ | — | ◯ | — | — | — |
| LIST COMPONENT | | | | | | | |
| SUCCESSIVE VALUE | PROGRESS BAR | ◯ | — | — | — | — | — |
| COMPONENT | SLIDER | ◯ | — | — | — | — | — |
| COMBINED MODEL | TABLE | ◯ | — | — | — | — | — |
| COMPONENT | TREE | ◯ | — | — | — | — | — |

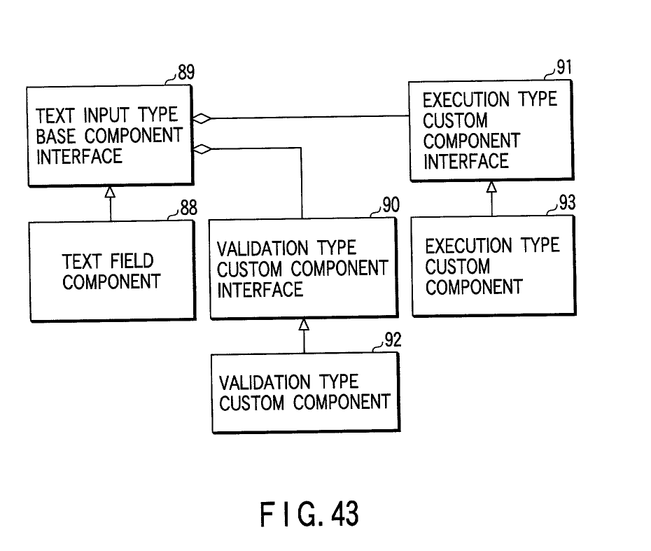

FIG. 43 is a sequence chart illustrating a relationship between the base component and custom component in a text field component.

An operation that a text field component 88 provides to the outside is defined as a text input type base component interface 89. The text field component 88 that actually operates is created by mounting the text input type base component interface 89. The base component interface defines what custom component is mounted. A validation type custom component interface 90 and execution type custom component interface 91 are mounted on the text input type base component interface 89. In order to define a specific operation of the custom component, the validation type custom component 91 is created by mounting the validation type custom component interface 90. In addition, the execution type custom component 93 is created by mounting the execution type custom component interface 91.

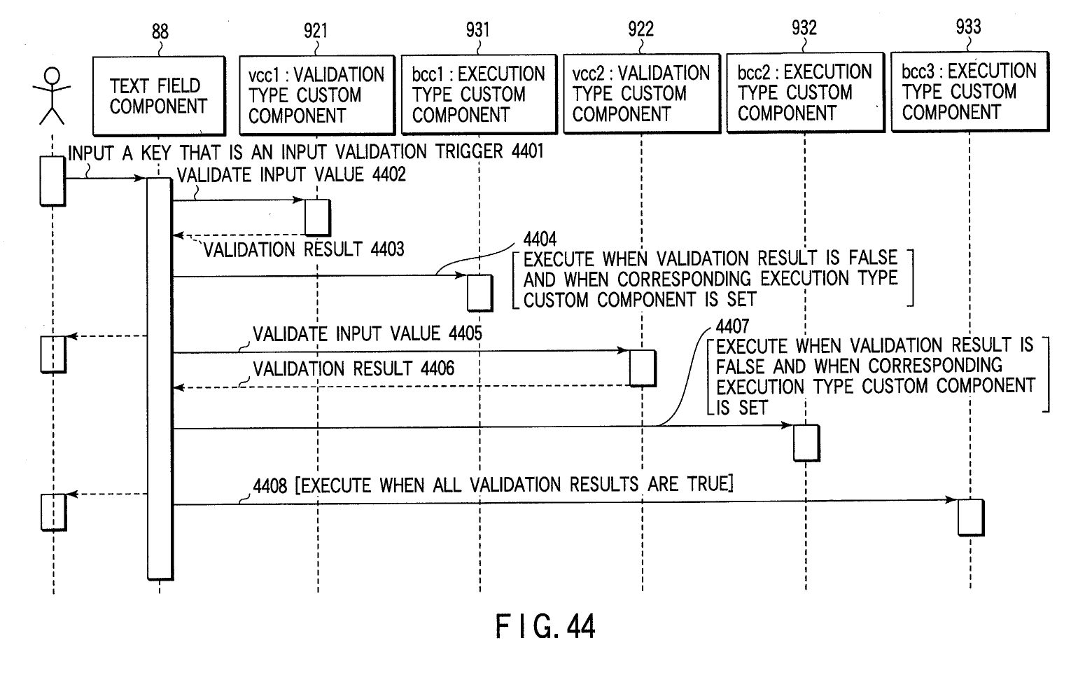

FIG. 44 is a sequence chart illustrating processing procedures between the base component and custom component in the text field component 88.

A validation custom component 921 is an instance of the validation type custom component 92 shown in FIG. 43.

An execution type custom component 931 is an instance of the execution type custom component shown in FIG. 43. This execution type custom component 931 is associated with the validation type custom component 921.

A validation type custom component 922 is an instance of the validation type custom component shown in FIG. 43. This validation type custom component 922 is independent of the validation type custom component 921.

An execution type custom component 932 is an instance of the execution type custom component shown in FIG. 43. This execution type custom component 932 is independent of the execution type custom component 931, and is associated with the validation type custom component 922.

An execution type custom component 933 is an instance of the execution type custom component shown in FIG. 43. This execution type custom component 933 is independent of the other execution type custom components 931 and 932, respectively.

The user input a key defined as an input validation trigger after a text has been inputted to the text field component 88 (4401). The key defined as an input validation trigger can be set freely.

The text field component 88 calls an operation for validating an input value of the validation type custom component 921 that is a first component of the registered validation type custom components (4402).

The validation type custom component 921 validates a value passed from a text field component 88, and returns the result as a return value (4403).

If the validation result is false, an operation for executing the execution type custom component 931 registered to be associated with the validation custom component 921 to handle an error is called, and processing is terminated (4404).

In the case where the validation result is true, an operation for validating an input value of the validation type custom component 922 that is a second component of the registered validation custom components is called to perform next validation (4405).

The validation type custom component 922 validates a value passed from the text field component 88, and returns the result as a return value (4406).

If the validation result is false, an operation for executing the execution type custom component 922 registered to be associated with the validation type custom component 922 is called to handle an error, and processing is terminated (4407).

As has been described above, validation is repeated by all the validation type custom components 921 and 922. In the case where all the validation results are true, an operation for executing the execution type custom component 933 registered as a defaulted operation is called (4408).

This processing can be specifically described as follows.

The validation type custom component 921 shown in FIG. 44 is a component that judges whether or not the inputted value is a half-width number.

The execution type custom component 931 is a component that displays a message “Input a half-width number”.

The validation type custom component 922 is a component that judges whether or not the inputted value is equal to or smaller than a predetermined number of digits, and the attribute value of digits to be judged is preset as an eight digit.

The execution type custom component 932 is a component that displays a message “input a numeral equal to or smaller than 8 digits”.

The execution type custom component 933 is a component in which comma editing is applied to the inputted value.

In addition, assume that an Enter key is specified as an input validation trigger.

In this case, when a user inputs a text to the text field component, and press the Enter key, in the case where the inputted value is a half-width number equal to or smaller than eight digits, like “123456787”, for example, the comma edited value “12,345,678” is displayed.

For example, in the case where the inputted value includes a character other than half-width number like “a1234567”, a message “Input a half-width number” is displayed.

For example, in the case where the inputted value consists of only half-width numbers, like “123456789”, a message “Input a numeral equal to or less than eight digits” is displayed.

As has been described above, in the present embodiment, a GUI component configures a screen is provided with a portion based on a common nature that does not depend on applications. On the other hand, a portion that depends on applications and requires some change is mounted on the GUI component. Data is exchanged in accordance with a predetermined interface between the GUI component and the custom component mounted to the GUI component.

In this manner, the screen program development efficiency is remarkably improved. Specifically, the following advantageous effect can be achieved.

In the case where list data is searched for from a database or file, thereby creating a program displayed on a screen, there can be eliminated a work of writing a SQL statement to create a search class, writing a code for calling the search class, and writing a code for setting the search result to the GUI component.

In addition, in the case of creating a program for validating a user text input, there can be eliminated a work of writing a code for acquiring a user key input event, creating a class activated by the user key input event, writing an input validation routine into that class, and outputting an message indicating the input validation result or writing a code for editing a format.

In the case of creating a program for reflecting a value inputted on the popup window on a main screen component, there can be eliminated a work of writing a code for displaying a popup window according to an event when a button is pressed, writing a code for acquiring the inputted value on the popup window, and writing a code for setting the acquired value to the main screen component.

In the case of creating a program for providing input data to an application, there can be eliminated a work of acquiring the data inputted to the screen from individual components, writing a code for collecting these components, and writing a code for passing the data to a business logic, and call it.

In the case of creating a screen program by dividing it, there is provided a unified method for providing access to component data via a panel. Thus, the component is merely allocated on the panel, enabling reuse. Hence, divisional development is facilitated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer program product stored on a computer-readable medium for controlling a screen, the program product comprising:
a dynamic display information acquisition program code that acquires dynamic display processing identification information for specifying dynamic display processing reserved for acquiring display contents to be dynamically changed and display attribute information used by dynamic display processing specified by this dynamic display processing identification information; and
an attribute information providing program code that provides the display attribute information corresponding to dynamic display processing for dynamic display processing specified by the dynamic display processing identification information acquired by the dynamic display information acquisition program code.

2. A computer program product stored on a computer-readable medium for controlling a screen as claimed in claim 1, wherein said attribute information providing program code incorporates dynamic display processing specified by dynamic display processing identification information acquired by said dynamic display information acquisition program code.

3. A computer program product stored on a computer-readable medium for controlling a screen as claimed in claim 1, wherein said dynamic display processing is processing for carrying out search based on the contents of display attribute information.

4. A computer program product stored on a computer-readable medium for acquiring a dynamic display information, the program product comprising:
a acquiring program code that acquires dynamic display processing identification information for specifying dynamic display processing reserved for acquiring display contents to be dynamically changed and display attribute information used by dynamic display processing specified by this dynamic display processing identification information; and
a providing program code that provides the dynamic display processing identification information and display attribute information acquired by the acquiring program code to a screen control program code that provides the display attribute information used in the dynamic display processing to dynamic display processing specified by the dynamic display processing identification information.

5. A computer program product stored on a computer-readable medium for acquiring a dynamic display information as claimed in claim 4, further comprising:
a format converting program code that converts the dynamic display processing identification information and display attribute information described in a predetermined format in a format that can be handled by a screen control program code.

6. A computer program product stored on a computer-readable medium for transacting a screen display, the program product comprising:
a storage program code that judges whether or not the contents of input to the screen are normal, and in the case where it is judged that the contents are normal, stores the input contents as screen display transaction information; and
a reproduction program code that, in the case where a re-display instruction is accepted, reproduces normal input contents at an arbitrary time on a screen by referring to the screen display transaction information stored by the storage program code.

7. A computer readable recording medium having recorded therein a screen component interface program code that exchanges data between a screen components hierarchically combined to configure a screen program.

8. A computer readable recording medium having recorded therein a screen component interface program code that exchanges data between a screen component reserved for configuring a screen program and a custom component loaded to add at least one of the functions and data to this screen component.

9. A method for creating a screen program by a computer system, comprising the steps of:
displaying a screen for causing a user to select a screen component reserved for configuring a screen program and its disposition position;
receiving a user selection contents of the screen component and its disposition position;
displaying a screen for causing a user to select a custom component loaded to add at least one of the functions and data to the screen component selected by the user;
receiving a user selection contents of the custom component; and
loading a custom component to the screen component selected by the user to be provided as a constituent element of the screen program.
